(19) United States
(12) Patent Application Publication
(10) Pub. No.: US 2024/0359252 A1
(43) Pub. Date: Oct. 31, 2024

(54) STEEL WELDED MEMBER

(71) Applicant: NIPPON STEEL CORPORATION, Tokyo (JP)

(72) Inventors: Takuya MITSUNOBU, Tokyo (JP); Hiroshi TAKEBAYASHI, Tokyo (JP); Keitaro MATSUDA, Tokyo (JP)

(73) Assignee: NIPPON STEEL CORPORATION, Tokyo (JP)

(21) Appl. No.: 18/579,759

(22) PCT Filed: Sep. 30, 2022
(86) PCT No.: PCT/JP2022/036855

§ 371 Date: Jan. 16, 2024

(30) Foreign Application Priority Data
Oct. 1, 2021 (JP) 2021-162778

(51) Int. Cl. B23K 11/11; B23K 11/16; B23K 103/04; C21D 9/46; C22C 38/00; C22C 38/02; C22C 38/04; C22C 38/06; C23C 2/06; C23C 2/40

(52) U.S. Cl. CPC B23K 11/11; B23K 11/166; C21D 9/46; C22C 38/001; C22C 38/002; C22C 38/02; C22C 38/04; C22C 38/06; C23C 2/06; C23C 2/40; B23K 2103/04

(57) ABSTRACT

A steel welded member having a high LME resistance of a spot weld, i.e., a steel welded member comprised of a plurality of Zn-based plated steel materials, each comprised of a steel material and a Zn-based plating layer on its surface, joined by at least one spot weld, in which

at least one of the Zn-based plated steel materials has a 780 MPa or more tensile strength, that steel material has a chemical composition containing, by mass %,

C: 0.05 to 0.40%,

Si: 0.2 to 3.0%,

Mn: 0.1 to 5.0%,

sol. Al: 0.4 to 1.50%, etc. and having a balance of Fe and impurities, and,

in a region of 10 to 300 μm from an end of a pressure weld of the spot weld, a difference of a Zn penetration depth of Zn from a Zn-based plating layer penetrating a steel material minus a depth of an internal oxidation layer formed at the steel material is within 0.1 to 10.0 μm in range.

### FIELD

The present invention relates to a steel welded member. More specifically, the present invention relates to a steel welded member having a high LME resistance of a spot weld.

### BACKGROUND

In recent years, the steel sheet used in automobiles, building materials, and various other fields has been made increasingly higher in strength. For example, in the automotive field, high strength steel sheet is being increasingly used for the purpose of lightening the weight of car bodies so as to improve fuel economy. Such high strength steel sheet typically contains C, Si, Mn, and other elements for raising the strength of the steel.

In general, high corrosion resistance is sought from such high strength steel sheet, particularly when used outdoors, so as to secure strength and aesthetic appearance. As steel sheet for improving corrosion resistance, Zn-based plated steel sheet comprised of steel sheet and a Zn-based plating layer (for example, Zn—Al plating layer, Zn—Al—Mg plating layer, etc.) formed on the same has been known.

For example, a member for automotive use formed using Zn-based plated steel sheet is often assembled by shaping parts by press forming etc., then welding (for example, spot welding) them together. Accordingly, in a member comprised of a plurality of plated steel sheet parts joined through welds, not only corrosion resistance of the plated steel sheet parts themselves, but also LME resistance of the welds (for example, spot welds) is sought. In general, it is known that welds are inferior in corrosion resistance compared with sound parts which are not welded.

In relation to this, PTL 1 discloses a welding method able to form a high quality spot welded joint suppressing LME by continuing to squeeze and hold the welding electrodes (extending the holding time after welding) even after stopping a weld current. Further, PTL 2 discloses a method of improvement of the corrosion resistance, tensile strength, and fatigue strength of a joint obtained by spot welding high strength plated steel sheet parts comprising treating fracture of a nugget and a fracture part of a heat affected zone around the same by ultrasonic impact from one side or both sides of the spot weld.

### CITATIONS LIST

### Patent Literature

[PTL 1] Japanese Unexamined Patent Publication No. 2017-047475

[PTL 2] Japanese Unexamined Patent Publication No. 2005-103608

### SUMMARY

### Technical Problem

High strength plated steel sheet is used in automobile members, home electrical appliances, building materials, and various other fields. If welding together plated steel sheet parts comprised of high strength steel sheet and Zn-based plating layers etc. on the same, since the plated steel sheet parts will be worked at a high temperature (for example, 900° C. or so), they can be worked in a state with the Zn contained in the plating layers melted. In this case, the melted Zn sometimes penetrates the steel resulting in fracture inside the steel sheet parts. Such a phenomenon is called “liquid metal embrittlement (LME)”. It is known that due to that LME, the fatigue characteristics of the steel sheet parts fall. Therefore, to prevent LME fracture, it is effective to keep Zn etc. contained in the plating layers from penetrating the steel sheet parts.

In PTL 1, the relationship of the weld residual stress and the penetration of molten metal is studied, but the metal microstructure for improving the LME resistance of a spot weld is not studied much at all. Further, the invention described in PTL 2 performs ultrasonic impact treatment to repair a fracture occurring at a spot weld, etc. to thereby prevent penetration of moisture into the fracture and raise the corrosion resistance. For this reason, in PTL 2, improvement of the LME resistance of a spot weld as welded is not necessarily sufficiently studied.

The present invention, in view of such an actual situation, has as its technical problem to provide a steel welded member having high LME resistance of a spot weld.

### Solution to Problem

The inventors discovered that, to solve the above technical problem, in the microstructure near an end of a pressure weld of a spot weld, making the Zn and other molten metal diffuse inside the crystal grains and thereby relatively keeping the Zn and other molten metal from penetrating and building up at the crystal grain boundaries is important for improvement of the LME resistance and that if welding Zn-based plated steel materials having a steel material microstructure containing crystal grains at which such Zn or other molten metal easily diffuse, the depth of diffusion (penetration) of Zn in the steel materials (inside the crystal grains) becomes deeper than the depths of the internal oxidation layers formed at the steel materials and discovered that by using Zn-based plated steel materials prescribed by the present invention, the LME resistance of a spot weld of the plated steel materials is greatly improved.

The present invention is based on the above discovery and has as its gist the following:

(1) A steel welded member comprised of a plurality of Zn-based plated steel materials, each comprised of a steel material and a Zn-based plating layer on its surface, joined by at least one spot weld, in which steel welded member,

at least one of the Zn-based plated steel materials has a 780 MPa or more tensile strength,

that steel material has a chemical composition containing, by mass %,
C: 0.05 to 0.40%,
Si: 0.2 to 3.0%,
Mn: 0.1 to 5.0%,
sol. Al: 0.4 to 1.50%,
P: 0.0300% or less,
S: 0.0300% or less,
N: 0.0100% or less,
B: 0 to 0.010%,
Ti: 0 to 0.150%,
Nb: 0 to 0.150%,
V: 0 to 0.150%,
Cr: 0 to 2.00%,
Ni: 0 to 2.00%,
Cu: 0 to 2.00%,
Mo: 0 to 1.00%,
W: 0 to 1.00%,
Ca: 0 to 0.100%,
Mg: 0 to 0.100%,
Zr: 0 to 0.100%,
Hf: 0 to 0.100%, and
REM: 0 to 0.100% and having a balance of Fe and impurities, and,

in a region of 10 to 300 μm from an end of a pressure weld of the spot weld, a difference of a Zn penetration depth of Zn from a Zn-based plating layer penetrating a steel material minus a depth of an internal oxidation layer formed at the steel material is within 0.1 to 10.0 μm in range.

(2) The steel welded member according to aspect (1), wherein the difference is within 1.5 to 10.0 μm in range.

(3) The steel welded member according to aspect (1) or (2), wherein in a region of more than 1000 μm from the end of the pressure weld of the spot weld, the Zn-based plating layer has a chemical composition containing, by mass %, Al: 0.3 to 1.5% and having a balance of Zn and impurities.

(4) The steel welded member according to aspect (1) or (2), wherein in a region of more than 1000 μm from the end of the pressure weld of the spot weld, the Zn-based plating layer has a chemical composition containing, by mass %, Al: 0 to less than 0.1% and having a balance of Zn and impurities.

### Advantageous Effects of Invention

According to the present invention, in a steel welded member obtained by spot welding a plurality of Zn-based plated steel materials, it is possible to provide a steel welded member greatly improved in LME resistance of the spot weld by making the difference of a Zn penetration depth of Zn from a Zn-based plating layer penetrating a steel material minus the depth of an internal oxidation layer formed in the steel material 0.1 to 10.0 μm in range in a region of 10 to 300 μm from an end of a pressure weld of the spot weld. As a result, it becomes possible to provide a member excellent in LME resistance overall, in particular a member for automotive use.

### BRIEF DESCRIPTION OF DRAWINGS

FIG. 1 is a cross-sectional view for explaining a spot weld of an illustrative steel welded member according to the present invention.

FIG. 2 is a view for explaining an end of a pressure weld and a region near the end of an illustrative steel welded member according to the present invention and is an enlarged view of the broken line part of FIG. 1.

FIG. 3 gives photographs of a cross-section of an illustrative steel sheet according to the present invention.

FIG. 4 is a schematic view of a cross-section (internal oxidation layer) of an illustrative steel sheet according to the present invention.

FIG. 5 is a schematic view explaining a relationship of a Zn penetration depth and internal oxidation layer depth.

### DESCRIPTION OF EMBODIMENTS

### Steel Welded Member

The steel welded member according to the present invention is a steel welded member comprised of a plurality of Zn-based plated steel materials, each comprised of a steel material and a Zn-based plating layer on its surface, joined by at least one spot weld, in which,

at least one of the Zn-based plated steel materials has a 780 MPa or more tensile strength,

that steel material (the at least one Zn-based plated steel material) has a chemical composition containing, by mass %,
C: 0.05 to 0.40%,
Si: 0.2 to 3.0%,
Mn: 0.1 to 5.0%,
sol. Al: 0.4 to 1.50%,
P: 0.0300% or less,
S: 0.0300% or less,
N: 0.0100% or less,
B: 0 to 0.010%,
Ti: 0 to 0.150%,
Nb: 0 to 0.150%,
V: 0 to 0.150%,
Cr: 0 to 2.00%,
Ni: 0 to 2.00%,
Cu: 0 to 2.00%,
Mo: 0 to 1.00%,
W: 0 to 1.00%,
Ca: 0 to 0.100%,
Mg: 0 to 0.100%,
Zr: 0 to 0.100%,
Hf: 0 to 0.100%, and
REM: 0 to 0.100% and having a balance of Fe and impurities, and,

in a region of 10 to 300 μm from an end of a pressure weld of the spot weld, a difference of a Zn penetration depth of Zn from a Zn-based plating layer penetrating a steel material minus a depth of an internal oxidation layer formed at the steel material is within 0.1 to 10.0 μm in range.

In recent years, for example, lighter weight has been sought from members for automotive use for the purpose of improving fuel efficiency. To achieve lighter weight, so-called “high strength steel sheet” (for example, tensile strength 440 MPa or more) has been used for members for automotive use. High corrosion resistance has been sought from such high strength steel sheet, in particular high strength steel sheet to be used outdoors, from the viewpoint of securing strength and aesthetic appearance. In recent years, as high strength steel sheet excellent in corrosion resistance, much use has been made of Zn-based plated steel sheet comprised of steel sheet and a Zn-based plating formed on the same. On the other hand, members for automotive use are usually obtained by shaping plated steel sheet parts by press forming etc., then assembling them into the desired member shape by welding (for example, spot welding). Accordingly, members for automotive use include spot welds between the plated steel materials, so having high LME resistance is demanded not only at the plated steel sheet parts but also near the spot welds. On the other hand, the spot welds are more easily penetrated by Zn from the Zn-based plating layer toward the inside of the steel sheet compared with sound parts which are not welded. For this reason, sometimes penetration of Zn advances near the spot welds and LME easily occurs, whereby the desired properties of members for automotive use (in particular properties relating to strength) can no longer be secured. It should be noted that the LME resistance will be explained later, but in general is evaluated by the presence of any LME fractures after welding and their lengths. (The longer the fractures, the more the LME resistance falls.) For this reason, the strength itself cannot be evaluated by merely the LME resistance. Therefore, as a precondition, the plated steel sheet before welding must itself have a predetermined strength.

Therefore, the inventors studied in detail methods for improving the LME resistance near a spot weld and as a result discovered that by treating a steel material having a predetermined chemical composition by a specific grinding treatment as annealing pretreatment and by annealing under predetermined conditions, forming a Zn-based plating layer on the obtained steel material to obtain a Zn-based plated steel material, and spot welding the Zn-based plated steel material to prepare a steel welded member, it is possible to greatly improve the LME resistance of the spot weld compared with the case of using a conventional plated steel material. If analyzing in detail the pressure weld of a spot weld of a steel welded member produced in this way, it was learned that at the region of 10 to 300 μm from the end, the difference of the Zn penetration depth of Zn from the Zn-based plating layer penetrating the steel material minus the depth of the internal oxidation layer formed at the steel material is 0.1 to 10.0 μm in range. Therefore, the inventors discovered that by making the Zn penetration depth of Zn from the Zn-based plating layer penetrating the steel material exactly a predetermined distance larger (deeper) than the depth of the internal oxidation layer near the end of a pressure weld, the LME resistance near a spot weld is greatly improved compared with a steel welded member prepared using a conventional plated steel material. While being bound to a specific theory is not desirable, the following is considered as the reason why the LME resistance of the spot weld was improved. Overall, the surface layer of a steel material is formed with an internal oxidation layer including granular type internal oxides. Making the diffusion (penetration) depth of Zn at the steel material surface layer deeper than the depth of the internal oxidation layer formed at the steel material surface layer is realized by making the Zn and other molten metal diffuse to inside the crystal grains forming the microstructure of the surface layer of the steel material. In this case, penetration of Zn and other molten metal into the crystal grain boundaries is relatively suppressed. As one of the causes of LME, reportedly the Zn penetrating the grain boundaries act as starting points for fractures, so by making the Zn and other molten metal diffuse into the crystal grains and suppressing diffusion to the crystal grain boundaries, the LME resistance is improved. In other words, if spot welding a plated steel material prescribed in the present invention, the Zn and other molten metal diffuse into the crystal grains, diffusion to the crystal grain boundaries is suppressed, and the LME resistance near the spot welds can be greatly improved. Further, if the penetration depth of Zn etc. into the steel material is deeper than the internal oxidation layer depth, it can be deemed that the Zn and other molten metal is diffusing into the crystal grains. Therefore, the inventors developed a steel welded member having a high LME resistance of a spot weld extremely advantageous in particular in members for automotive use.

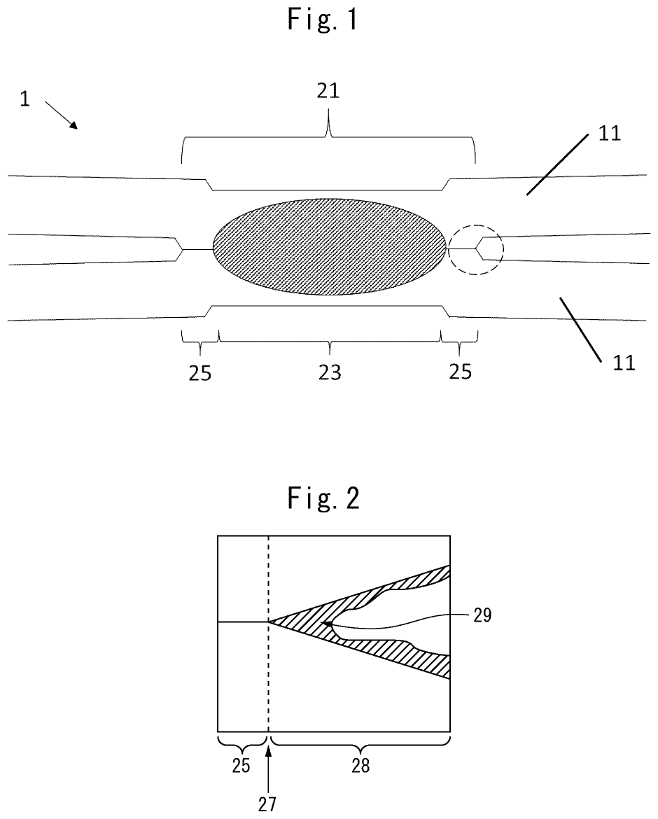

Below, the steel welded member according to the present invention will be explained in detail. The steel welded member according to the present invention is comprised of a plurality of Zn-based plated steel materials, each comprised of a steel material (for example, steel sheet) and a Zn-based plating layer on its surface, joined by at least one spot weld. Therefore, the steel welded member is comprised of a plurality of (i.e., two or more) Zn-based plated steel materials combined by spot welding. Each Zn-based plated steel material has a steel material and a Zn-based plating layer formed on that steel material. Between the steel material and the plating layer, another layer (for example, an Ni plating layer etc.) may also be contained. The steel welded member according to the present invention may include as little as one spot weld between the Zn-based plated steel materials or may include two or more spot welds. The Zn-based plating layer may be formed on one surface of the steel material or may be formed on both surfaces. However, to obtain the steel welded member according to the present invention, at least one of two Zn-based plated steel materials to be spot welded has a surface having a Zn-based plating layer as the surface to be joined by spot welding. Furthermore, to obtain the steel welded member according to the present invention, at least one of the Zn-based plated steel materials has a 780 MPa or more tensile strength and has a specific chemical composition. In this case, at the weld, the steel material can realize a high LME resistance. Only naturally, if the other material to be welded with is a steel material of the same quality as the at least one Zn-based plated steel material, a high LME resistance can be realized even at the weld of the other material. FIG. 1 shows a cross-section of a spot weld of an illustrative steel welded member according to the present invention. The steel welded member 1 is comprised of two Zn-based plated steel materials 11 joined by a spot weld 21. The spot weld 21 is typically comprised of a nugget 23 and a pressure weld 25.

### Tensile Strength

The at least one plated steel sheet according to the present invention preferably has high strength. Specifically, this indicates having a 780 MPa or more tensile strength. For example, the tensile strength may be 780 MPa or more, 800 MPa or more, or 900 MPa or more. The upper limit of the tensile strength is not particularly prescribed, but from the viewpoint of securing the toughness, for example, it may be 2000 MPa or less. The tensile strength may be measured by obtaining a JIS No. 5 tensile test piece and running a test compliant with JIS Z 2241 (2011). The long direction of the tensile test piece is not particularly limited, and may be a direction perpendicular to the rolling direction as well.

### Steel Material

Below, the steel material of the at least one Zn-based plated steel material in the present invention will be explained in detail. The shape of the steel material is not particularly limited, but is preferably steel sheet. If the steel material in the present invention is steel sheet, the sheet thickness is not particularly limited, but for example may be 0.1 to 3.2 mm.

### Chemical Composition of Steel Material

The chemical composition contained in the steel material of the at least one Zn-based plated steel material in the present invention will be explained next. The “%” relating to the contents of the elements mean “mass %” unless otherwise indicated. In the numerical ranges in the chemical composition, numerical ranges expressed using “to” mean ranges including the numerical values described before and after the “to” as the lower limit values and the upper limit values unless otherwise indicated.

### (C: 0.05 to 0.40%)

C (carbon) is an important element in securing the strength of steel. If the C content is insufficient, sufficient strength is liable to be unable to be secured. Further, due to an insufficient C content, the desired form of the fine internal oxides in the fine ferrite phases will sometimes not be obtainable. Therefore, the C content is 0.05% or more, preferably 0.07% or more, more preferably 0.10% or more, still more preferably 0.12% or more. On the other hand, if the C content is excessive, the weldability is liable to fall. Therefore, the C content is 0.40% or less, preferably 0.35% or less, more preferably 0.30% or less.

### (Si: 0.2 to 3.0%)

Si (silicon) is an element effective for raising the strength of steel. If the Si content is insufficient, sufficient strength is liable to be unable to be secured. Furthermore, Si forms oxides together with Mn which thereby function as pinning particles and contribute to refinement of the ferrite phases. In other words, if Si is insufficient, the desired fine ferrite phases and the fine internal oxides in the ferrite phases are liable to be unable to be sufficiently formed near the surface layer of the steel sheet. Therefore, the Si content is 0.2% or more, preferably 0.3% or more, more preferably 0.5% or more, still more preferably 1.0% or more. On the other hand, if the Si content is excessive, deterioration of the surface properties is liable to be triggered and promotion of external oxide growth is liable to be invited. Therefore, the Si content is 3.0% or less, preferably 2.5% or less, more preferably 2.0% or less.

### (Mn: 0.1 to 5.0%)

Mn (manganese) is an element effective for obtaining hard structures and thereby improving the strength of steel. If the Mn content is insufficient, sufficient strength is liable to be unable to be secured. Furthermore, Mn forms oxides together with Si which thereby function as pinning particles and contribute to refinement of the ferrite phases. In other words, if Mn is insufficient, the desired fine ferrite phases and the fine internal oxides in the ferrite phases are liable to be unable to be sufficiently formed near the surface layer of the steel sheet. Therefore, the Mn content is 0.1% or more, preferably 0.5% or more, more preferably 1.0% or more, still more preferably 1.5% or more. On the other hand, if the Mn content is excessive, Mn segregation causes the metal microstructure to become uneven, the workability is liable to drop, and promotion of external oxide growth is liable to be invited. Therefore, the Mn content is 5.0% or less, preferably 4.5% or less, more preferably 4.0% or less, even more preferably 3.5% or less.

(Sol. Al: 0.4 to 1.50%)

Al (aluminum) is an element acting as a deoxidizing element. If the Al content is insufficient, a sufficient effect of deoxidation is liable to be unable to be secured. Furthermore, the desired oxides, in particular the fine internal oxides of the fine ferrite phases, are liable to be unable to be sufficiently formed near the surface layer of the steel sheet. Al is contained in internal oxides together with Si and Mn. These function as pinning particles and contribute to refinement of the ferrite phases. The Al content may be 0.4% or more, but to more sufficiently obtain fine internal oxides of fine ferrite phases, the Al content is 0.5% or more, preferably 0.6% or more, more preferably 0.7% or more. On the other hand, if the Al content is excessive, a drop in the workability and deterioration of the surface properties are liable to be triggered, and promotion of external oxide growth is liable to be invited. Therefore, the Al content is 1.50% or less, preferably 1.20% or less, more preferably 0.80% or less. The Al content means the content of so-called acid soluble Al (sol. Al).

### (P: 0.0300% or Less)

P (phosphorus) is an impurity generally contained in steel. If the P content is more than 0.0300%, the weldability is liable to fall. Therefore, the P content is 0.0300% or less, preferably 0.0200% or less, more preferably 0.0100% or less, still more preferably 0.0050% or less. The lower limit of the P content is not particularly prescribed, but from the viewpoint of the production costs, the P content may be more than 0% or 0.0001% or more.

### (S: 0.0300% or Less)

S (sulfur) is an impurity generally contained in steel. If the S content is more than 0.0300%, the weldability falls and, furthermore, the amount of precipitation of MnS increases and bendability and other workability are liable to fall. Therefore, the S content is 0.0300% or less, preferably 0.0100% or less, more preferably 0.0050% or less, still more preferably 0.0020% or less. The lower limit of the S content is not particularly prescribed, but from the viewpoint of desulfurization costs, the S content may be more than 0% or 0.0001% or more.

### (N: 0.0100% or Less)

N (nitrogen) is an impurity generally contained in steel. If the N content is more than 0.0100%, the weldability is liable to fall. Therefore, the N content is 0.0100% or less, preferably 0.0080% or less, more preferably 0.0050% or less, still more preferably 0.0030% or less. The lower limit of the N content is not particularly prescribed, but from the viewpoint of the production costs, the N content may be more than 0% or 0.0010% or more.

### (B: 0 to 0.010%)

B (boron) is an element raising the hardenability to contribute to improvement of strength. Further, it is an element segregating at the grain boundaries to strengthen the grain boundaries and improve toughness, so may be contained in accordance with need. Therefore, the B content is 0% or more, preferably 0.001% or more, more preferably 0.002% or more, still more preferably 0.003% or more. On the other hand, from the viewpoint of securing sufficient toughness and weldability, the B content is 0.010% or less, preferably 0.008% or less, more preferably 0.006% or less.

### (Ti: 0 to 0.150%)

Ti (titanium) is an element precipitating as TiC during cooling of the steel and contributing to improvement of strength, so may be included in accordance with need. Therefore, the Ti content is 0% or more, preferably 0.001% or more, more preferably 0.003% or more, still more preferably 0.005% or more, furthermore preferably 0.010% or more. On the other hand, if excessively contained, coarse TiN is produced and the toughness is liable to be damaged, so the Ti content is 0.150% or less, preferably 0.100% or less, more preferably 0.050% or less.

### (Nb: 0 to 0.150%)

Nb (niobium) is an element contributing to improvement of strength through improvement of hardenability, so may be contained in accordance with need. Therefore, the Nb content is 0% or more, preferably 0.010% or more, more preferably 0.020% or more, still more preferably 0.030% or more. On the other hand, from the viewpoint of securing sufficient toughness and weldability, the Nb content is 0.150% or less, preferably 0.100% or less, more preferably 0.060% or less.

### (V: 0 to 0.150%)

V (vanadium) is an element contributing to improvement of strength through improvement of hardenability, so may be contained in accordance with need. Therefore, the V content is 0% or more, preferably 0.010% or more, more preferably 0.020% or more, still more preferably 0.030% or more. On the other hand, from the viewpoint of securing sufficient toughness and weldability, the V content is 0.150% or less, preferably 0.100% or less, more preferably 0.060% or less.

### (Cr: 0 to 2.00%)

Cr (chromium) is effective for raising the hardenability of steel to raise the strength of steel, so may be contained in accordance with need. Therefore, the Cr content is 0% or more, preferably 0.10% or more, more preferably 0.20% or more, still more preferably 0.50% or more, furthermore preferably 0.80% or more. On the other hand, if excessively contained, a large amount of Cr carbides is formed and conversely the hardenability is liable to be impaired, so the Cr content is 2.00% or less, preferably 1.80% or less, more preferably 1.50% or less.

### (Ni: 0 to 2.00%)

Ni (nickel) is effective for raising the hardenability of steel to raise the strength of steel, so may be contained in accordance with need. Therefore, the Ni content is 0% or more, preferably 0.10% or more, more preferably 0.20% or more, still more preferably 0.50% or more, furthermore preferably 0.80% or more. On the other hand, excessive addition of Ni invites a rise in costs, so the Ni content is 2.00% or less, preferably 1.80% or less, more preferably 1.50% or less.

### (Cu: 0 to 2.00%)

Cu (copper) is effective for raising the hardenability of steel to raise the strength of steel, so may be contained in accordance with need. Therefore, the Cu content is 0% or more, preferably 0.10% or more, more preferably 0.20% or more, still more preferably 0.50% or more, furthermore preferably 0.80% or more. On the other hand, from the viewpoint of keeping down the drop in toughness or fracture of the slab after casting or the drop in weldability, the Cu content is 2.00% or less, preferably 1.80% or less, more preferably 1.50% or less.

### (Mo: 0 to 1.00%)

Mo (molybdenum) is effective for raising the hardenability of steel to raise the strength of steel, so may be contained in accordance with need. Therefore, the Mo content is 0% or more, preferably 0.10% or more, more preferably 0.20% or more, still more preferably 0.30% or more. On the other hand, from the viewpoint of suppressing a drop in toughness and weldability, the Mo content is 1.00% or less, preferably 0.90% or less, more preferably 0.80% or less.

### (W: 0 to 1.00%)

W (tungsten) is effective for raising the hardenability of steel to raise the strength of steel, so may be contained in accordance with need. Therefore, the W content is 0% or more, preferably 0.10% or more, more preferably 0.20% or more, still more preferably 0.30% or more. On the other hand, from the viewpoint of keeping the toughness and weldability from falling, the W content is 1.00% or less, preferably 0.90% or less, more preferably 0.80% or less.

### (Ca: 0 to 0.100%)

Ca (calcium) is an element having the action of contributing to control of inclusions, in particular finer dispersion of inclusions, and raising the toughness, so may be contained in accordance with need. Therefore, the Ca content is 0% or more, preferably 0.001% or more, more preferably 0.005% or more, still more preferably 0.010% or more, furthermore preferably 0.020% or more. On the other hand, if excessively contained, deterioration of the surface properties sometimes appears, so the Ca content is 0.100% or less, preferably 0.080% or less, more preferably 0.050% or less.

### (Mg: 0 to 0.100%)

Mg (magnesium) is an element having the action of contributing to control of inclusions, in particular finer dispersion of inclusions, and raising the toughness, so may be contained in accordance with need. Therefore, the Mg content is 0% or more, preferably 0.001% or more, more preferably 0.003% or more, still more preferably 0.010% or more. On the other hand, if excessively contained, deterioration of the surface properties sometimes appears, so the Mg content is 0.100% or less, preferably 0.090% or less, more preferably 0.080% or less.

### (Zr: 0 to 0.100%)

Zr (zirconium) is an element having the action of contributing to control of inclusions, in particular finer dispersion of inclusions, and raising the toughness, so may be contained in accordance with need. Therefore, the Zr content is 0% or more, preferably 0.001% or more, more preferably 0.005% or more, still more preferably 0.010% or more. On the other hand, if excessively contained, deterioration of the surface properties sometimes appears, so the Zr content is 0.100% or less, preferably 0.050% or less, more preferably 0.030% or less.

### (Hf: 0 to 0.100%)

Hf (hafnium) is an element having the action of contributing to control of inclusions, in particular finer dispersion of inclusions, and raising the toughness, so may be contained in accordance with need. Therefore, the Hf content is 0% or more, preferably 0.001% or more, more preferably 0.005% or more, still more preferably 0.010% or more. On the other hand, if excessively contained, deterioration of the surface properties sometimes appears, so the Hf content is 0.100% or less, preferably 0.050% or less, more preferably 0.030% or less.

### (REM: 0 to 0.100%)

A REM (rare earth metal) is an element having the action of contributing to control of inclusions, in particular finer dispersion of inclusions, and raising the toughness, so may be contained in accordance with need. Therefore, the REM content is 0% or more, preferably 0.001% or more, more preferably 0.005% or more, still more preferably 0.010% or more. On the other hand, if excessively contained, deterioration of the surface properties sometimes appears, so the REM content is 0.100% or less, preferably 0.050% or less, more preferably 0.030% or less. It should be noted that “REM” is an abbreviation for “rare earth metal” and means an element belonging to the lanthanoids. A REM is usually added as a mischmetal.

In the steel sheet according to the present invention, the balance other than the above chemical composition is comprised of Fe and impurities. In this case, “impurities” means constituents entering due to various factors in the production process such as, first and foremost, the raw materials such as ore and scrap, when industrially producing steel sheet, and contained in a range not having a detrimental effect on the properties of the steel sheet according to the present invention.

In the present invention, the chemical composition of the steel sheet may be analyzed using an elemental analysis method known to persons skilled in the art. For example, it is performed by inductively coupled plasma mass spectrometry (ICP-MS). However, for C and S, the combustion-infrared absorption method may be used, while for N, the inert gas melting-thermal conductivity method may be used. These analyses may be performed by samples of steel sheet taken by a method compliant with JIS G0417: 1999. It should be noted that if a plating layer is attached, the chemical composition of the steel sheet can be determined by dissolving the plating layer in an acid solution including an inhibitor for inhibiting corrosion of the steel sheet and analyzing the steel sheet from which the plating layer was removed by ICP (inductively coupled plasma) mass spectrometry. The position of measurement of the chemical composition of the steel sheet is preferably a region of more than 1000 μm from the end of the pressure weld of the spot weld. At the heat affected zone (HAZ), there is a possibility of the chemical composition of the steel sheet fluctuating and accurate measurement is liable to be impossible, so it is preferable to measure the chemical composition at the so-called non-heat affected zone (nonHAZ) of the region more than 1000 μm from the end of the pressure weld of the spot weld which is not affected by the heat of welding.

Further, regarding the amount of sol. Al, this may be measured by the following procedure. Specifically, the steel sheet is electrolyzed and the residue recovered by filter paper is analyzed by inductively coupled plasma mass spectrometry. The detected Al amount is deemed the precipitated Al amount. On the other hand, the T. Al (also referred to as the “total Al”) is measured without electrolyzing the steel sheet. The value of the T. Al minus the precipitated Al amount is defined as the sol. Al.

### Surface Layer

In the present invention, the “surface layer” of steel sheet means the region from the surface of the steel sheet (in case of plated steel sheet, the interface of the steel sheet and plating layer) down to a predetermined depth in the sheet thickness direction. The “predetermined depth” is typically 50 μm or less. It should be noted that the shapes, number densities, etc. of the fine ferrite phases and their internal oxides according to the present embodiment are measured in the “surface layer” in the range from the surface of the steel sheet (interface of plating layer/steel sheet) down to a depth of 2 μm toward the steel sheet side. This range will sometimes be referred to as “near the surface layer”. Further, as explained later, a spot weld includes a part where the steel sheet constituents and/or plating layer constituents are melted then solidified. The steel sheet surface (interface of plating layer/steel sheet) is difficult to differentiate. Therefore, the “surface layer” and “near the surface layer” are differentiated outside of the spot weld.

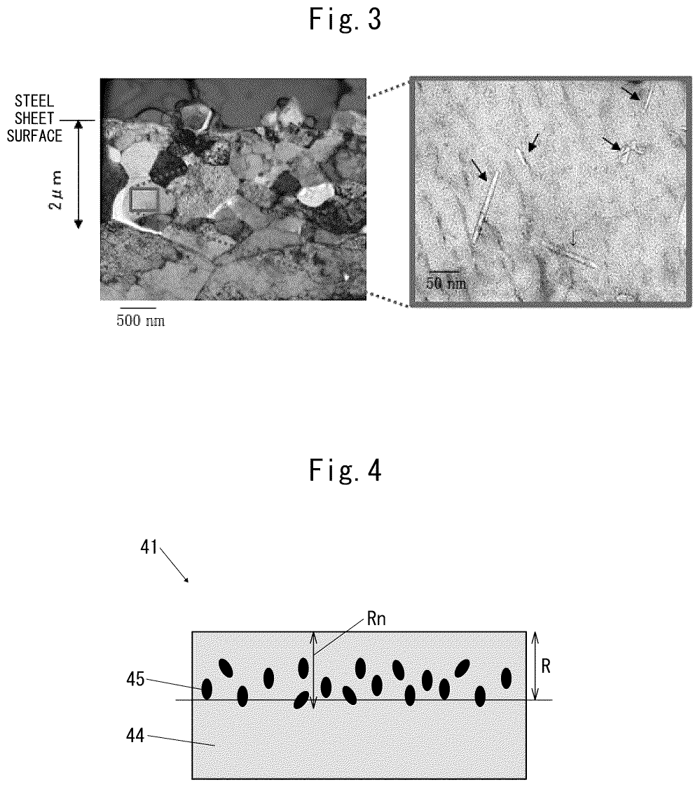

As illustrated in FIG. 3, in the plated steel sheet according to a preferable embodiment, fine ferrite phases and their internal oxides are present at the surface layer of the steel sheet.

### Ferrite Phases

In the present embodiment, “ferrite phases” means crystal phases forming the steel matrix and having the crystal structures of ferrite. In actuality, ferrite phases are typically present three-dimensionally as spherical shapes or substantially spherical shapes at the surface layer of the steel sheet, so if examining the cross-section of the surface layer of the steel sheet, the ferrite phases are typically observed as circular shapes or substantially circular shapes.

### (Circle Equivalent Diameters of Ferrite Phases)

In the present embodiment, the ferrite phases have circle equivalent diameters of 1 μm (1000 nm) or less. This range of ferrite phases will sometimes be referred to as “fine ferrite phases”. By controlling the circle equivalent diameters to such a range, it is possible to make fine ferrite phases disperse to near the surface layer of the steel sheet. The internal oxides of the fine ferrite phases function well as trap sites for Zn potentially penetrating at the time of welding plated steel sheet comprised of steel sheet and a plating layer formed on the same. On the other hand, if the circle equivalent diameters become more than 1 μm (1000 nm), the number of ferrite phases sometimes falls and the desired number density is liable to be unable to be obtained. The circle equivalent diameters of the ferrite phases are not particularly prescribed, but may be 2 nm or more, preferably 10 nm or more, so as to include the later explained internal oxides.

### (Number Density of Ferrite Phases)

In a preferred embodiment, near the surface layer (region from surface layer down to depth of 2 μm), the number density of the fine ferrite phases is 2 to 30/μm². By controlling the number density to such a range, it is possible to make a large amount of fine ferrite phases disperse at the surface layer of the steel sheet. Inside, internal oxides can be contained. The internal oxides function well as trap sites for Zn potentially penetrating when welding plated steel sheet comprised of steel sheet and a plating layer formed on it. The circle equivalent diameters of the ferrite phases are fine (circle equivalent diameters 1 μm or less), so (compared with coarse ferrite phases), the Zn penetrating the ferrite phases quickly reaches the internal oxides where the Zn is quickly trapped. Conversely, if the ferrite phases are coarse, the Zn penetrating the ferrite phases requires time until reaching the internal oxides and the Zn is sometimes not trapped. Therefore, if the number density of the ferrite phases is less than 2/μm², the relatively coarse ferrite phases become more numerous, much of the internal oxides functioning as trap sites of Zn become present in the coarse ferrite phases and do not sufficiently function as trap sites of Zn, and excellent LME resistance is liable to be unable to be obtained. The number density of fine ferrite phases is preferably 3/μm² or more, more preferably 4/μm² or more, still more preferably 5/μm² or more. Fine ferrite phases surround the internal oxides functioning as trap sites for Zn. From this viewpoint, the greater the amount they are present in, the more preferable. However, under general manufacturing conditions, the upper limit of the number density of fine ferrite phases becomes 30/μm² or less, so the upper limit of the number density of fine ferrite phases in a preferable embodiment is 30/μm² or less and may also be 25/μm² or less and 20/μm² or less.

The size (circle equivalent diameter) and number density of the ferrite phases are measured by a scan type electron microscope (SEM) and transmission type electron microscope (TEM). The specific measurements are performed as follows: A cross-section of the surface layer of the steel sheet is examined under an SEM to obtain an SEM image containing the ferrite phases. Based on the cross-sectional SEM image, a test piece for TEM examination is taken using FIB processing so as to include the interface of the plating layer/steel sheet. In the TEM examination, the ferrite phases falling under the shapes shown in the present embodiment (circle equivalent diameter 1 μm or less) are identified in the range from the steel sheet surface (interface of plating layer/steel sheet) to a depth of 2 μm to the steel sheet side and their number density is measured. As the examination position, the position is made 2.0 μm from the steel sheet surface in the depth direction (direction vertical to surface of steel sheet) and is made 1.0 μm of any position of the TEM image in the width direction (direction parallel to surface of steel sheet). In other words, the examined field is 2.0 μm×1.0 μm. Next, the TEM image of the region obtained in the above way is extracted and digitalized for separating the ferrite phases (and grain boundaries (or phase boundaries)), the areas of the ferrite phases are calculated from the digitalized image, the circle equivalent sizes (nm) of the ferrite phases are found as diameters of circles having equal areas to those areas, i.e., circle equivalent diameters, and phases having circle equivalent diameters of 1 μm or less (1000 nm or less) in range are deemed fine ferrite phases according to the present embodiment. Furthermore, the numbers of the fine ferrite phases in the digitalized image are counted. The average value of the numbers of fine ferrite phases in a total of 10 regions found in this way is defined as the number density (/μm²) of fine ferrite phases. It should be noted that if only parts of the ferrite phases are observed in examined regions, i.e., if not all of the contours of the ferrite phases are inside the examined regions, these are not counted in the numbers.

### Fine Internal Oxides

In a preferred embodiment, “fine internal oxides” means oxides present inside the above-mentioned fine “ferrite phases”. Several fine internal oxides may be present in a single ferrite phase. The fine internal oxides are not arranged in position following any specific rules (for example, in a line) and may be arranged at random.

### (Particle Sizes of Fine Internal Oxides)

In a preferred embodiment, the particle sizes of the fine internal oxides are circle equivalent diameters of 2 nm or more and 100 nm or less. By controlling the particle sizes to such a range, it is possible to make the fine internal oxides disperse in the fine ferrite phases present near the surface layer of the steel sheet. The fine internal oxides function well as trap sites of the Zn potentially penetrating at the time of welding plated steel sheet comprised of steel sheet and a plating layer formed on the same. On the other hand, if the particle sizes become more than 100 nm, the number of the fine internal oxides sometimes falls and the desired number density is liable to be unable to be obtained. The finer the fine internal oxides, the higher the specific surface area and the more improved the reactivity as trap sites, so the particle sizes of the fine internal oxides may be 50 nm or less, preferably 20 nm or less or less than 20 nm. On the other hand, the lower limit is 2 nm or more. The reason is that the amount of Zn which one particle can trap falls. Zn cannot be sufficiently trapped, and the fine internal oxides are liable to not sufficiently function as trap sites of Zn. The shapes of the fine internal oxides are not particularly limited, but the aspect ratio (maximum line segment length crossing a fine internal oxide (long axis)/maximum line segment length crossing the fine internal oxide vertical to the long axis (short axis)) may be 1.5 or more. The short axis may also be less than 20 nm. While being bound to a specific theory is not desirable, if the aspect ratios of the fine internal oxides become higher, the possibility of contacting Zn penetrating the ferrite phases rises and, it is believed, the trap efficiency of Zn rises.

### (Number Density of Fine Internal Oxides)

Further, the number density of fine internal oxides is 3/μm² or more. By controlling the number density to such a range, it is possible to make a large amount of fine internal oxides be surrounded by the fine ferrite phases present at the surface layer of the steel sheet. The fine internal oxides function well as trap sites for Zn potentially penetrating at the time of welding plated steel sheet comprised of steel sheet and a plating layer formed on the same. On the other hand, if the number density is less than 3/μm², the number density is not sufficient for trap sites of Zn, the fine internal oxides do not sufficiently function as trap sites of Zn, and good LME resistance is liable to be unable to be obtained. The number density of fine internal oxides is preferably 6/μm² or more, more preferably 8/μm² or more, still more preferably 10/μm² or more. From the viewpoint of the fine internal oxides functioning as trap sites of Zn, the larger the amount present, the better, but the circle equivalent diameters of the ferrite phases surrounding the fine internal oxides are 1 μm or less, so it is possible to set an upper limit on the number density of fine internal oxides. 30/μm² or less, 25/μm² or less, or 20/μm² or less are also possible.

The particle sizes and number density of the fine internal oxides are measured by a scan type electron microscope (SEM) and transmission type electron microscope (TEM) by a technique similar to the ferrite phases. The specific measurements are performed as follows: A cross-section of the surface layer of the steel sheet is examined under the SEM to obtain an SEM image containing the fine ferrite phases. Based on the cross-sectional SEM image, a test piece for TEM examination is taken using FIB processing so as to include the interface of the plating layer/steel sheet. In the TEM examination, the fine internal oxides falling under the shapes shown in a preferred embodiment (particle size 2 to 100 μm) are identified in the range from the steel sheet surface (interface of plating layer/steel sheet) to a depth of 2 μm to the steel sheet side and their number density is measured. As the examination position, the position is made 2.0 μm from the steel sheet surface in the depth direction (direction vertical to surface of steel sheet) and is made 1.0 μm of any position of the TEM image in the width direction (direction parallel to surface of steel sheet). In other words, the examined field region is 2.0 μm×1.0 μm. Next, the TEM image of the region obtained in the above way is extracted and digitalized for separating the oxide parts and steel parts, the areas of the fine internal oxide parts are calculated from the digitalized image, the particle sizes (nm) of the fine internal oxides are found as diameters of circles having equal areas to those areas, i.e., circle equivalent diameters, and fine internal oxides having particle sizes of 2 nm or more and 100 nm or less in range are deemed fine internal oxides according to a preferred embodiment. Furthermore, the number of the fine internal oxides in the digitalized image are counted. The average value of the numbers of fine internal oxides in a total of 10 regions found in this way is defined as the number density (/μm²) of fine internal oxides. It should be noted that if only parts of the fine internal oxides are observed in examined regions, i.e., if not all of the contours of the fine internal oxides are inside the examined regions, these are not counted in the numbers.

### Chemical Composition of Fine Oxides

In a preferable embodiment, the fine internal oxides contain, in addition to oxygen, one or more of the elements included in the above-mentioned steel sheet. Typically, they have a chemical composition including Si, O, and Fe and sometimes furthermore Mn or Al. The fine internal oxides may also contain elements able to be contained in the above-mentioned steel sheet (for example, Cr etc.) in addition to these elements. While being bound to a specific theory is not desirable, if Al is included in the fine internal oxides, it is believed that the effect as trap sites of Zn will become higher. A higher content of Al contained in the fine internal oxides is desirable and may be 20 mass % or more. If the fine internal oxides are oxides of Al and O, so-called alumina, the Al content in the oxides becomes the highest or becomes 53 mass %. This may be made the upper limit of the Al content.

### Internal Oxidation Layer

Further, in the plated steel sheet according to the present invention, there is an internal oxidation layer present at the surface layer of the steel sheet. In the production of steel sheet, in general, heat treatment such as annealing is performed after the rolling. Further, among the elements typically included in high strength steel sheet, the easily oxidizable Si, Mn, and Al sometimes bond with the oxygen in the atmosphere at the time of heat treatment and form a layer including oxides near the surface of the steel sheet. As the form of such a layer, a form where oxides containing Si, Mn, or Al are formed as a film at the outside (surface) of the steel sheet (external oxidation layer) and a form where oxides are formed at the inside (surface layer) of the steel sheet may be mentioned (internal oxidation layer). In the present invention, an “internal oxidation layer” means a region including “granular type oxides” at the surface layer of the steel sheet.

### Granular Type Oxides

In the present invention, “granular type oxides” mean oxides dispersed in a granular form at the crystal phases of the steel (aggregate structures of crystal grains). However, “granular type oxides” are defined as not including fine internal oxides present in the fine ferrite phases explained above. Further, “granular” means present separated from each other in the crystal phases of the steel. For example, it means having an aspect ratio of 1.0 to 5.0 (maximum line segment length crossing a granular type oxide (long axis)/maximum line segment length crossing an oxide vertical to the long axis (short axis)). “Dispersed in a granular form” means the positions of the grains of the oxides are not arranged by any specific rule (for example, in a line) and are arranged at random. In actuality, granular type oxides are typically present three-dimensionally as spherical shapes or substantially spherical shapes at the surface layer of the steel sheet, so if examining the cross-section of the surface layer of the steel sheet, the granular type oxides are typically observed as circular shapes or substantially circular shapes. In FIG. 4, as an example, a granular type oxide 45 appearing as a substantially circular shape is shown.

### (Particle Sizes)

In a preferable embodiment, the particle sizes of the granular type oxides are 150 nm or more and 600 nm or less. By controlling the particle sizes to such a range, it is possible to make the granular type oxides disperse at the surface layer of the steel sheet. The granular type oxides function well as trap sites of the hydrogen suppressing the penetration of hydrogen in corrosive environments. On the other hand, if the particle sizes become more than 600 nm, the number of granular type oxides sometimes falls and the desired number density is liable to be unable to be obtained. The lower limit of the particle sizes of the granular type oxides is 150 nm or more. The lower limit (150 nm) of the particle sizes of the granular type oxides is set from the viewpoint of measurement precision so as to avoid fine internal oxides in the fine ferrite phases and the granular type oxides becoming difficult to discriminate. Further, the finer the granular type oxides, the higher the specific surface area and the more improved the reactivity as trap sites, but the amount of hydrogen which one particle can trap falls, hydrogen cannot be sufficiently trapped, and the oxides are liable to not sufficiently function as trap sites of hydrogen.

### (Number Density of Granular Type Oxides)

Preferably, the number density of granular type oxides is 4.0/25 μm² or more. By controlling the number density to such a range, it is possible to make a large amount of fine\ granular type oxides be dispersed at the surface layer of the steel sheet. The granular type oxides function well as trap sites for hydrogen suppressing hydrogen penetration in corrosive environments. On the other hand, if the number density is less than 4.0/25 μm², the number density is not sufficient for trap sites of hydrogen and the granular type oxides are liable to not sufficiently function as trap sites of hydrogen. The number density of granular type oxides is preferably 6.0/25 μm² or more, more preferably 8.0/25 μm² or more, still more preferably 10.0/25 μm² or more. From the viewpoint of the granular type oxides functioning as trap sites of hydrogen, the larger the amount present, the better, but granular type oxides sometimes become starting points of LME fracture. If more than 30/25 μm², the LME resistance is liable to fall. Therefore, the number density of granular type oxides may be 30/25 μm² or less, 25/25 μm² or less, or 20/25 μm² or less.

The particle sizes and number density of the granular type oxides are measured by a scan type electron microscope (SEM). The specific measurements are performed as follows: A cross-section of the surface layer of the steel sheet is examined under the SEM to obtain an SEM image containing the granular type oxides. From the SEM image, as examined regions, a total of 10 regions of 5.0 μm (depth direction)×5.0 μm (width direction) are selected. As the examination position of each region, the position is made 5.0 μm in the region from the steel sheet surface down to 20.0 μm in the depth direction (direction vertical to surface of steel sheet) and is made 5.0 μm of any position of the SEM image in the width direction (direction parallel to surface of steel sheet). Next, the SEM image of the region selected in the above way is extracted and digitalized for separating the oxide parts and steel parts, the areas of the oxide parts are calculated from the digitalized image, the particle sizes (nm) of the granular type oxides are found as diameters of circles having equal areas to those areas, i.e., circle equivalent diameters, and oxides having particle sizes of 150 nm or more and 600 nm or less in range are deemed granular type oxides. Furthermore, the numbers of the internal oxides in the digitalized images are counted. The average value of the numbers of granular type oxides in the total of 10 regions found in this way is defined as the number density (25/μm²) of granular type oxides. It should be noted that, if only parts of the granular type oxides are observed in examined regions, i.e., if not all of the contours of the granular type oxides are inside the examined regions, these are not counted in the numbers.

### Chemical Composition of Granular Type Oxides

In the present invention, the granular type oxides (below, also simply referred to as “oxides”) contain, in addition to oxygen, one or more of the elements included in the above-mentioned steel sheet. Typically, they have a chemical composition including Si, O, and Fe and sometimes furthermore Mn or Al. The oxides may also contain elements able to be contained in the above-mentioned steel sheet (for example, Cr etc.) in addition to these elements.

### <Plated Steel Sheet>

The plated steel sheet according to the present invention has the above-mentioned steel sheet according to the present invention and a plating layer containing Zn on the same. This plating layer may be formed on one surface of the steel sheet and may be formed on both surfaces. As the plating layer containing Zn, for example, a hot dip galvanized layer, hot dip galvannealed layer, electrogalvanized layer, electrogalvannealed layer, etc. may be mentioned. More specifically, as the plating type, for example, Zn-0.2% Al (GI), Zn-(0.3 to 1.5) % Al, Zn-4.5% Al, Zn-0.09% Al-10% Fe (GA), Zn-1.5% Al-1.5% Mg, or Zn-11% Al-3% Mg-0.2% Si, Zn-11% Ni, Zn-15% Mg, etc. can be used. In the present invention, the Zn-based plating layer need only contain Zn. Plating layers in which the most abundant constituent is not Zn are also included. It should be noted that the steel material and the Zn-based plating layer may also have another layer between them.

### Chemical Composition of Zn-Based Plating Layer

The chemical composition of the Zn-based plating layer in a preferred embodiment will be explained next. The “%” relating to the contents of the elements mean “mass %” unless otherwise indicated. In the numerical ranges in the chemical composition of the plating layer, numerical ranges expressed using “to” mean ranges including the numerical values described before and after the “to” as the lower limit values and the upper limit values unless otherwise indicated.

### (Al: 0 to 60.0%)

Al is an element causing improvement of the corrosion resistance of the plating layer by inclusion or alloying together with Zn, so may be contained in accordance with need. Therefore, the Al content may also be 0%. To form a plating layer containing Zn and Al, preferably the Al content may be 0.01% or more. For example, it may also be 0.1% or more, 0.3% or more, 0.5% or more, 1.0% or more, or 3.0% or more. On the other hand, if more than 60.0%, the effect of causing improvement of the corrosion resistance becomes saturated, so the Al content may be 60.0% or less. For example, it may be 55.0% or less, 50.0% or less, 40.0% or less, 30.0% or less, 20.0% or less, 10.0% or less, or 5.0% or less. The detailed mechanism is not clear, but if the Al in the plating layer is 0.3 to 1.5% in range, due to the effect of the Al, the speed of penetration of Zn into the steel grain boundaries is greatly reduced and the LME resistance can be made to be improved. Therefore, from the viewpoint of improvement of the LME resistance, the Al in the plating layer is preferably 0.3 to 1.5%. On the other hand, in electroplating, the basis weight is easily controlled by the amount of electricity, so the Al in the plating layer may be made 0 to less than 0.1%. Typically, the plating layer may be a chemical composition containing, by mass %, Al: 0.3 to 1.5% and having a balance of Zn and impurities. The plating layer may also be a chemical composition containing, by mass %, Al: 0 to less than 0.1% and having a balance of Zn and impurities. Due to the plating layer of such ranges of chemical compositions, the LME resistance can be further improved.

### (Mg: 0 to 15.0%)

Mg is an element included or alloyed together with Zn and Al to thereby improve the corrosion resistance of the plating layer, so may be contained in accordance with need. Therefore, the Mg content may also be 0%. To form a plating layer containing Zn, Al, and Mg, preferably the Mg content may be made 0.01% or more. For example, it may be 0.1% or more, 0.5% or more, 1.0% or more, or 3.0% or more. On the other hand, if more than 15.0%, Mg will not dissolve into the plating bath and will float up as oxides. If galvanizing in this plating bath, oxides will deposit on the plating surface layer and cause poor appearance. Alternatively, nonplating parts will be liable to be formed. Therefore, the Mg content may be 15.0% or less. For example, it may be 10.0% or less and 5.0% or less.

### (Fe: 0 to 15.0%)

Fe diffuses from the steel sheet if heat treating the plated steel sheet after forming a plating layer containing Zn on the steel sheet and can be included in the plating layer. Therefore, in a state where no heat treatment is performed, since Fe is not contained in the plating layer, the Fe content may also be 0%. Further, the Fe content may be 1.0% or more, 2.0% or more, 3.0% or more, 4.0% or more, or 5.0% or more. On the other hand, the Fe content may be 15.0% or less. For example, it may also be 12.0% or less, 10.0% or less, 8.0% or less, or 6.0% or less.

### (Si: 0 to 3.0%)

Si is an element further causing improvement of the corrosion resistance if included in the plating layer containing Zn, in particular a Zn—Al—Mg plating layer, so may be contained in accordance with need. Therefore, the Si content may also be 0%. From the viewpoint of improvement of the corrosion resistance, the Si content may be, for example, 0.005% or more, 0.01% or more, 0.05% or more, 0.1% or more, or 0.5% or more. Further, the Si content may be 3.0% or less, 2.5% or less, 2.0% or less, 1.5% or less, or 1.2% or less.

The basic chemical composition of the plating layer is as explained above. Furthermore, the plating layer may optionally contain one or more of Sb: 0 to 0.50%, Pb: 0 to 0.50%, Cu: 0 to 1.00%, Sn: 0 to 1.00%, Ti: 0 to 1.00%, Sr: 0 to 0.50%, Cr: 0 to 1.00%, Ni: 0 to 1.00%, and Mn: 0 to 1.00%. While not particularly limited, from the viewpoint of causing the actions and functions of the basic constituents forming the plating layer to sufficiently be manifested, the total content of these optional elements is preferably made 5.00% or less. Making it 2.00% or less is more preferable.

In the plating layer, the balance besides the above constituents is comprised of Zn and impurities. The “impurities” in the plating layer means constituents entering due to various factors in the production process such as, first and foremost, the raw materials, when producing the plating layer and not intentionally added to the plating layer. In the plating layer, as impurities, elements besides the basic constituents and optional constituents explained above may also be include in trace amounts within a range not obstructing the effect of the present invention.

The chemical composition of the plating layer can be determined by dissolving the plating layer in an acid solution containing an inhibitor for inhibiting corrosion of the steel sheet and measuring the obtained solution by ICP (inductively coupled plasma) mass spectrometry. It should be noted that at a steel weld according to the present embodiment, the position for measuring the chemical composition of the plating layer is preferably a region of more than 1000 μm from the end of the pressure weld of the spot weld. At the heat affected zone (HAZ), there is a possibility of the chemical composition of the steel sheet fluctuating and accurate measurement is liable to be impossible, so it is preferable to measure the chemical composition at the so-called non-heat affected zone (nonHAZ) of the region more than 1000 μm from the end of the pressure weld of the spot weld which is not affected by the heat of welding.

The thickness of the plating layer may be, for example, 3 to 50 μm. Further, the amount of deposition of the plating layer is not particularly limited, but for example may be 10 to 170 g/m² per side. In the present invention, the amount of deposition of the plating layer is determined by dissolving the plating layer in an acid solution containing an inhibitor for inhibiting corrosion of the base iron and measuring the change in weight before and after dissolving the plating.

### Spot Weld

The steel welded member according to the present invention includes at least one spot weld between the above-mentioned Zn-based plated steel materials. Therefore, a plurality of (two or more) Zn-based plated steel materials are joined by spot welding. FIG. 1 is a cross-sectional view for explaining a spot weld of an illustrative steel welded member according to the present invention. In FIG. 1, two Zn-based plated steel materials 11 are joined through a spot weld 21. Usually, if two Zn-based plated steel materials 11 are spot welded, as shown in FIG. 1, a part called a “nugget 23” comprised of the steel constituents and/or plating layer constituents melted then solidified at the part squeezed by the electrodes is formed. Further, at the outside of that nugget 23, a pressure weld 25 joined without the constituents melting is formed. Accordingly, the spot weld 21 contains the nugget 23 and pressure weld 25. Typically, it is comprised of only the nugget 23 and pressure weld 25. The nugget 23 and pressure weld 25 differ in chemical composition, so, for example, can be easily discriminated by a backscattered electron image (BSE image) of the scan type electron microscope (SEM). In the present invention, the shape and composition of the nugget 23 are not particularly limited.

### (Pressure Weld)

The steel welded member according to the present invention has a difference of the Zn penetration depth of Zn from the Zn-based plating layer penetrating the steel material minus the depth of the internal oxidation layer formed at the steel material of 0.1 to 10 μm in range at a region of 10 to 300 μm from the end of the pressure weld of the spot weld (deep Zn penetration depth). Preferably, the difference of the Zn penetration minus the depth of the internal oxidation layer is 1.5 to 10 μm in range (deep Zn penetration depth). Here, in the present invention, the “end of the pressure weld” means the end of the spot weld at the plurality of Zn-based plated steel materials comprised of the boundary of the part of the plurality of Zn-based plated steel materials joined by welding (pressure weld) and the part not joined. In more detail, the “end of the pressure weld” is present inside the broken lines of FIG. 1 and is expressed by the numeral 27 in FIG. 2. Therefore, the “region of 10 to 300 μm from the end of the pressure weld” means the 10 to 300 μm region of the Zn-based plated steel material extending from the boundary (numeral 27 of FIG. 2) of a joined part 25 of two Zn-based plated steel materials and a nonjoined part 28 (also called “separation part 28”) in the opposite direction (right side in FIG. 2) to the direction of the nugget 23. In FIG. 2, the plating layer of that region is shown by numeral 29 (hatched). Below, the 10 to 300 μm region from the end of the pressure weld of a spot weld will also be referred to as simply the “region near the end”.

### (Zn Penetration Depth)

In the steel welded member according to the present invention, at the region near the end, Zn from the Zn-based plating layer penetrates the steel material. That penetration depth is also simply referred to as the “Zn penetration depth”. The Zn penetration depth can be easily identified by analyzing the elements of the cross-sectional microstructure of the steel material by an SEM-EDS and finding the ratio of composition of Zn. The starting point of the depth is the steel sheet surface (interface of plating layer/steel sheet). The further inside the steel material, the greater (deeper) the Zn penetration depth. The Zn penetration depth sometimes fluctuates depending on the measurement location, so the SEM power is made 2000× or more, any five fields (each field region being 30 μm×30 μm) are selected, the positions where the interfaces of the plating layer/steel material (base iron) become close to the centers of the fields are examined, and the maximum Zn penetration depth in the five fields is defined as the “Zn penetration depth”.

While being bound to a specific theory is not desirable, in the present invention, the following is considered as the mechanism of action by which Zn from the Zn-based plating layer penetrates the steel material. Due to the welding, at the region near the end, the Zn contained in the plating layer melts. The molten Zn diffuses from the interface of the steel sheet provided with the plating layer (interface of plating layer and steel sheet) in the depth direction of the steel sheet. At this time, the molten Zn diffuses through the grain boundaries of the crystal grains forming the steel sheet microstructure and diffuses from the grain boundaries to the insides of the crystal grains as well. If fine internal oxides are present inside the crystal grains, the Zn is trapped by those fine internal oxides. In a preferable embodiment, the ferrite phases near the steel sheet surface layer are fine, so (compared with the case where the ferrite phases are coarse), there are more routes of the grain boundaries (or phase interfaces) and the distances from the grain boundaries (or phase interfaces) to the fine internal oxides inside the grains (or inside the phases) are short, so the molten Zn quickly proceeds to be trapped by the fine internal oxides of the ferrite phases. Such a trap action is repeated from the interface of the steel sheet toward the inside, whereby Zn from the Zn-based plating layer penetrates inside of the steel material. It should be noted that even if Zn diffuses to the surface layer of the steel sheet, the metal microstructure of the surface layer of the steel sheet is typically comprised of a metal microstructure softer than the inside of the steel sheet (for example, ⅛ position or ¼ position of sheet thickness), so even if Zn is present (diffused) at the surface layer of the steel sheet, liquid metal embrittlement (LME) fracture does not become a particular problem.

### (Depth of Internal Oxidation Layer)

In the steel sheet according to the present invention, the “internal oxidation layer” is a layer formed inside of the steel sheet including the granular type oxides 45. Therefore, the “internal oxidation layer” is comprised of the region running from the surface of the steel sheet down to the furthest position where the granular type oxides are present. Accordingly, the “depth of internal oxidation layer”, as shown in FIG. 4 as “Rn”, means the distance from the surface of the steel sheet 41 (in case of plated steel sheet, the interface of the steel sheet and the plating layer) to the furthest position from the surface of the steel sheet 41 where granular type oxides 45 are present when advancing in the thickness direction of the steel sheet 41 (direction vertical to surface of steel sheet). However, the surface of an actual steel sheet has asperities. Depending on which location (point) of the steel sheet surface is selected, the position of the furthest granular type oxide 45 from the steel sheet surface also fluctuates, so in the range of the region near the end, 10 examination regions (field region of each examination region being 30 μm×30 μm) are selected at suitable measurement intervals in the cross-sectional horizontal direction of the steel sheet 41 (direction parallel to surface of steel sheet 41). These 10 examination regions may overlap, but are adjusted so that the total length Lo of the widths of the steel sheet actually examined becomes 100 μm. In the measurement results, the distance from the surface of the steel sheet to the furthest position where granular type oxides are present is defined as the “depth of internal oxidation layer” (Rn). The average value of the depths of the internal oxidation layer at the 10 examination regions is defined as the “average depth of the internal oxidation layer” (sometimes also referred to as “R”). In FIG. 4, as an example of the “depth of internal oxidation layer” (Rn), the distance from the surface of the steel sheet to the granular type oxides 45 present at the deepest position is shown. In the steel sheet according to the present invention, the lower limit of the average depth R of the internal oxidation layer is not particularly prescribed, but if the layer is too shallow, sometimes the granular type oxides 45 will not be able to sufficiently disperse, so the lower limit is 1.0 μm or more, preferably 2.0 μm or more, more preferably 3.0 μm or more, furthermore preferably 4.0 μm or more. The upper limit of the average depth R is not particularly prescribed, but is substantially 30 μm or less.

The depth Rn of the internal oxidation layer, as shown in FIG. 4, is determined by examining a cross-section of the surface layer of the steel sheet 41. The specific measurement method is as follows: A cross-section of the surface layer of the steel sheet 41 is examined by an SEM. One examination position is randomly selected within the range of the region near the end. From there, at suitable measurement intervals, a total of 10 examination regions (field region of each examination region being 30 μm×30 μm) are selected. From the SEM image obtained for each examination region, the length L of the surface (i.e., the width of the SEM image) is measured. These 10 examination regions may overlap, but the total length L₀ of the widths of the steel sheet actually examined is made 100 μm and the depth measured is made the region from the surface of the steel sheet to 30 μm. Next, from the SEM images of the 10 examination regions, the positions of the granular type oxides 45 are identified. From the identified granular type oxides 45, any of the granular type oxides 45 present at the furthest position from the surface of the steel sheet is selected and the distance from the surface of the steel sheet 41 to the furthest position where any of the granular type oxides 45 is present is measured as the “depth of internal oxidation layer at each examined region”. In each of the measurement results of the 10 examination regions, the distance from the surface of the steel sheet 41 to the furthest position where any of the granular type oxides 45 is present is found as the “depth of internal oxidation layer” (Rn). The average value of the “depth of internal oxidation layer at each examination region” measured at the 10 locations is found as the “average depth of the internal oxidation layer” (sometimes also referred to as “R”).

### (Zn Penetration Depth-Internal Oxidation Layer Depth≥0.1 μm)

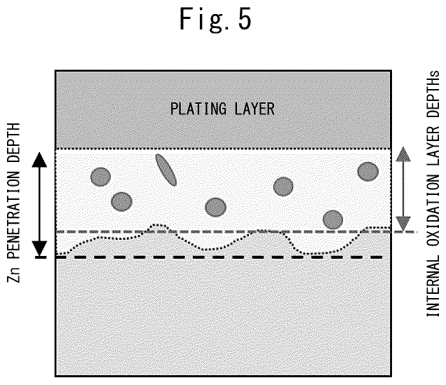

FIG. 5 is a schematic view explaining the relationship of the Zn penetration depth and internal oxidation layer depth. In general, the Zn penetration depth of the surface layer of the steel material being larger (deeper) than the internal oxidation layer depth means that the Zn and other molten metal have diffused to inside the crystal grains forming the microstructure of the surface layer of the steel material and have reached positions deeper than the granular internal oxides. If the difference of depth is 0.1 μm or more, the Zn etc. will sufficiently diffuse into the metal crystal grains of the steel sheet surface layer, penetration of Zn etc. into the crystal grain boundaries will be relatively suppressed, and the LME resistance will be improved. The deeper the penetration depth of Zn, the more Zn etc. will diffuse to the inside of the crystal grains, the more penetration into the crystal grain boundaries will be suppressed, and the more the LME resistance will be improved, so this is preferable. Therefore, Zn penetration depth-internal oxidation layer depth may be ≥1.5 μm. More preferably, the difference may be 2.0 μm or more, still more preferably 3.0 μm or more. On the other hand, even if the difference becomes too large, the effect of improvement of the LME resistance becomes saturated, so the upper limit of the difference may be made 10.0 μm. In other words, Zn penetration depth-internal oxidation layer depth≤10.0 μm.

### <Method of Production of Steel Welded Member>

Below, the preferable method of production of the steel welded member according to the present invention will be explained. The following explanation is intended to illustrate the characterizing method for producing the steel welded member according to the present invention and is not intended to limit the steel welded member to one produced by the method of production such as explained below.

The steel welded member according to the present invention can be obtained by a steel material preparation step of preparing steel materials, a plating step of forming Zn-based plating layers on the surfaces of the steel materials to prepare Zn-based plated steel materials, and a welding step of joining two plated steel materials by spot welding. To obtain the steel welded member according to the present invention, more specifically, a steel welded member with a difference of the Zn penetration depth of Zn from the Zn-based plating layer penetrating the steel material minus the depth of the internal oxidation layer formed at the steel material of 0.1 to 10.0 μm in range in the region near the end, in the steel material preparation step, it is effective to form fine ferrite phases and fine internal oxides inside of the same at the surface layer of each steel material. If spot welding after forming the Zn-based plating layer in the state where these fine ferrite phases and fine internal oxides are formed inside each steel material, the Zn and other molten parts of the plating layer constituents will flow out near the end of the pressure weld. i.e., at the region near the end, and the molten Zn will diffuse from the interface of the steel sheet provided with the plating layer (interface of plating layer and steel sheet) toward the depth direction of each steel sheet. At this time, the molten Zn will diffuse through the grain boundaries of the crystal grains forming the steel sheet microstructure and will diffuse from the grain boundaries toward the inside of the crystal grains as well. The ferrite phases near the steel sheet surface layer are fine, so (compared with the case where the ferrite phases are coarse), there are more routes of the grain boundaries (or phase interfaces) and the distances from the grain boundaries (or phase interfaces) to the internal oxides inside the grains (or inside the phases) are short, so the molten Zn quickly proceeds to be trapped by the internal oxides of the ferrite phases. Therefore, Zn etc. sufficiently diffuse to the inside of the metal crystal grains of the steel sheet surface layer, penetration of Zn etc. to the crystal grain boundaries is relatively suppressed, and the LME resistance is improved. To form fine ferrite phases and fine internal oxides inside of the same at the surface layer of each steel material, after rolling, it is effective to perform a predetermined annealing pretreatment step (grinding step), then perform an annealing step under predetermined conditions. Below, using as example the case of employing steel sheet as the steel material, the step of preparation of the steel materials, plating step, and welding step will be explained. It should be noted that the steel materials may be any shape. The method of production of the steel welded member when using steel materials other than steel sheet may be suitably changed in accordance with techniques known in the field of art.

### <Method of Production of Steel Sheet>

Below, the preferable method of production of the steel sheet according to the present invention will be explained. The following explanation is intended to illustrate the characterizing method for producing the steel sheet according to the present invention and is not intended to limit the steel sheet to one produced by the method of production such as explained below.

The steel sheet according to the present invention can, for example, be obtained by a casting step of casting molten steel adjusted in chemical composition so as to form a steel slab, a hot rolling step of hot rolling the steel slab to obtain hot rolled steel sheet, a coiling step of coiling the hot rolled steel sheet, a cold rolling step of cold rolling the coiled hot rolled steel sheet to obtain cold rolled steel sheet, a pickling step of pickling the cold rolled steel sheet, a pretreatment step of brush grinding the pickled cold rolled steel sheet, and an annealing step of annealing the pretreated cold rolled steel sheet. Alternatively, it is possible to not coil the steel sheet after the hot rolling step, but to pickle it and perform the cold rolling step as is.

### Casting Step

The conditions of the casting step are not particularly limited. For example, after smelting in a blast furnace, electric furnace, etc., various types of secondary refining may be performed, then the steel cast by the usual continuous casting, casting by the ingot method, or another method.

### Hot Rolling Step

The steel slab cast in the above way can be hot rolled to obtain hot rolled steel sheet. The hot rolling step is performed by directly hot rolling the cast steel slab or by reheating it after cooling once. If reheating, the heating temperature of the steel slab may be, for example, 1100° C. to 1250° C. In the hot rolling step, usually rough rolling and finish rolling are performed. The temperatures and rolling reductions in the rolling steps may be suitably changed in accordance with the desired metal microstructure and sheet thickness. For example, the end temperature of the finish rolling may be made 900 to 1050° C. and the rolling reduction of the finish rolling may be made 10 to 50%.

### Coiling Step

The hot rolled steel sheet can be coiled at a predetermined temperature. The coiling temperature may be suitably changed in accordance with the desired metal microstructure etc. For example, it may be 500 to 800° C. Before coiling or after coiling, then uncoiling, the hot rolled steel sheet may be subjected to predetermined heat treatment. Alternatively, it is possible to not perform the coiling step, but to pickle the steel sheet after hot rolling and perform the later explained cold rolling step as is.

### Cold Rolling Step

After pickling the hot rolled steel sheet etc., the hot rolled steel sheet can be cold rolled to obtain cold rolled steel sheet. The rolling reduction of the cold rolling may be suitably changed in accordance with the desired metal microstructure and sheet thickness. For example, it may be 20 to 80%. After the cold rolling step, for example, the steel sheet may be air-cooled to cool it down to room temperature.

### Pretreatment Step

To obtain fine ferrite phases and fine internal oxides inside of the same at the finally obtained surface layer of the steel sheet, it is effective to perform predetermined pretreatment before annealing the cold rolled steel sheet. In the pretreatment step, it becomes possible to more effectively introduce strain into the steel sheet. Due to the strain, dislocations in the metal microstructure of the steel sheet are promoted. At the time of annealing, oxygen easily penetrates the inside of the steel along the dislocations whereby oxides become easily formed inside of the steel sheet. As a result, this becomes advantageous for increasing the number density of internal oxides of the ferrite phases. Further, internal oxides function as pinning particles and contribute to making the ferrite phases finer. Accordingly, if performing such a predetermined step, the desired fine ferrite phases and fine internal oxides inside of the same are easily formed in the later explained annealing step. The pretreatment step includes grinding the cold rolled steel sheet surface by a heavy descaling grinding brush (brush grinding). As the heavy descaling grinding brush. D-100 made by Hotani may be used. At the time of grinding, the steel sheet surface may be coated with an NaOH 1.0 to 5.0% aqueous solution. The brush reduction may be 0.5 to 10.0 mm and the speed 100 to 1000 rpm. By performing brush grinding controlled to such a coating solution condition, brush reduction, and speed, in the later explained annealing step, fine ferrite phases and their internal oxides can be efficiently formed near the surface layer of the steel.

### Annealing Step

After the above pretreatment step, the cold rolled steel sheet is annealed. The annealing is preferably performed in a state, for example, applying 0.1 to 20 MPa tension. If applying tension at the time of annealing, it becomes possible to more effectively introduce strain into the steel sheet. Due to the strain, dislocations of the metal structure of the steel sheet are promoted. Oxygen easily penetrates inside the steel along the dislocations whereby oxides are easily formed inside the steel sheet. As a result, this becomes advantageous for increasing the number density of fine internal oxides of the fine ferrite phases.

From the viewpoint of causing the formation of fine ferrite phases and fine internal oxides inside of them, the holding temperature in the annealing step may be 700° C. to 900° C. If the holding temperature of the annealing step is less than 700° C., internal oxides are liable to be unable to be formed in a sufficiently large amount. Further, the pinning effect of the ferrite phase grain boundaries by the internal oxides is insufficient and sometimes the ferrite phases coarsen. For this reason, sometimes the LME resistance becomes insufficient. Further, sometimes sufficient strength cannot be obtained. On the other hand, if the holding temperature in the annealing step is more than 900° C., the internal oxides are liable to coarsen and the desired internal oxides are liable to not be formed. Further, if more than 900° C., even if internal oxides are formed, sometimes the ferrite phases will rapidly grow and the desired fine ferrite phases will be unable to be obtained. For this reason, sometimes the LME resistance will become insufficient. The rate of temperature rise up to the holding temperature is not particularly limited but may be 1 to 10° C./s. Further, the temperature rise may be performed in two stages of a first rate of temperature rise of 1 to 10° C./s and a second rate of temperature rise of 1 to 10° C./s different from the first rate of temperature rise.

The holding time at the holding temperature of the annealing step may be 0 to 300 seconds, preferably is 50 to 130 seconds. A holding time of 0 second means heat treatment at a predetermined dew point and, right after reaching a predetermined temperature, cooling without holding at an equal temperature. Even if the holding time is 0 second, during the temperature raising process, fine internal oxides are formed and LME resistance can be obtained. On the other hand, if the holding time is more than 300 seconds, the internal oxides are liable to coarsen and the LME resistance sometimes becomes insufficient.

During a rising temperature and during holding (equal temperature) of the annealing step. humidification is performed from the viewpoint of causing the formation of fine ferrite phases and fine internal oxides inside of them. The humidification is started during the rising temperature, at least from 300° C. At 300° C. or more, the dislocations in the ferrite phases of the steel sheet act as routes for diffusion of oxygen. Formation of internal oxides inside the ferrite phases is promoted by the oxygen contained in the humidifying atmosphere. In general, humidifying while raising the temperature from 300° C. or so to the holding temperature promotes the formation of an external oxidation film and causes a drop in plateability, and thus a person skilled in the art would avoid humidification from such a temperature raising process. Further, if the temperature for starting humidification is more than 300°° C., in particular is a temperature close to the holding temperature, for example, a temperature of 700° C. or so, the dislocations in the ferrite phases will be recovered from and disappear, so internal oxides will not be sufficiently formed inside the ferrite phases.

The atmosphere for humidification has a dew point of more than 10° C. and 20° C. or less, preferably 11 to 20° C., and has a hydrogen concentration of 8 to 20 vol % H₂, preferably 10 vol % H₂. It should be noted that the dew point before humidification is −40 to −60° C. After that, steam is introduced to control the dew point to a predetermined value. If the dew point is too low, the fine internal oxides are liable to not be sufficiently formed. Further, the pinning effect of the ferrite phase grain boundaries by the internal oxides will sometimes be insufficient and the ferrite phases will sometimes coarsen. For this reason, sometimes the LME resistance will become insufficient. On the other hand, if the dew point is too high, an external oxidation layer will sometimes form on the surface of the steel sheet and a plating layer will be unable to be obtained. Further, even within the above dew point range, if the hydrogen concentration is too low, the oxygen potential will become excessive and sometimes an external oxidation layer will be formed resulting in the plating layer not being obtained or further the internal oxidation layer will not be sufficiently formed. For this reason, the LME resistance will sometimes become insufficient. On the other hand, if the hydrogen concentration is too high, the oxygen potential will become insufficient, an internal oxidation layer will not be sufficiently formed, and an external oxidation layer is liable to be formed and a plating layer to not be obtained. Further, if internal oxides are formed in a sufficiently large amount, the pinning effect of the ferrite phase grain boundaries by the internal oxides will sometimes be insufficient and the ferrite phases will sometimes coarsen. For this reason, the LME resistance will sometimes become insufficient.

Furthermore, it is effective to remove the internal oxidation layer of steel sheet when performing an annealing step, in particular before brush grinding. During the above-mentioned rolling steps, in particular during the hot rolling step, sometimes an internal oxidation layer is formed at the surface layer of the steel sheet. The internal oxidation layer formed in such rolling steps is liable to obstruct the formation of fine internal oxides in the annealing step. Further, the pinning effect of the ferrite phase grain boundaries by the internal oxides is liable to be insufficient and ferrite phases to coarsen, and thus the internal oxidation layer is preferably removed by pickling etc. before annealing. More specifically, the depth of the internal oxidation layer of cold rolled steel sheet at the time of performing the annealing step is may be made 0.5 μm or less, preferably 0.3 μm or less, more preferably 0.2 μm or less, still more preferably 0.1 μm.

By performing the above-mentioned steps, steel sheet formed with fine ferrite phases and fine internal oxides inside of them at the surface layer of the steel sheet can be obtained.

### <Method of Production of Plated Steel Sheet>

Below, the preferable method of production of the plated steel sheet according to the present invention will be explained. The following explanation is intended to illustrate the characterizing method for producing the plated steel sheet according to the present invention and is not intended to limit the plated steel sheet to one produced by the method of production such as explained below.

The plated steel sheet according to the present invention can be obtained by performing a plating step forming a plating layer containing Zn on steel sheet produced as explained above.

### Plating Step

The plating step may be performed in accordance with a method known to persons skilled in the art. The plating step may, for example, be performed by hot dip coating and may be performed by electroplating. Preferably, the plating step is performed by hot dip coating. The conditions of the plating step may be suitably set considering the chemical composition, thickness, amount of deposition, etc. of the desired plating layer. After the plating, alloying may be performed. Typically, the conditions of the plating step are set so as to form a plating layer containing Al: 0 to 60.0%, Mg: 0 to 15.0%, Fe: 0 to 15%, Ni: 0 to 20%, and Si: 0 to 3% and having a balance of Zn and impurities. More specifically, the conditions of the plating step may be suitably set so as to form, for example, Zn-0.2% Al (GI), Zn-0.8% Al, Zn-4.5% Al, Zn-0.09% Al-10% Fe (GA), Zn-1.5% Al-1.5% Mg, or Zn-11% Al-3% Mg-0.2% Si, Zn-11% Ni, and Zn-15% Mg. From the viewpoint of improvement of the LME resistance, the Al of the plating layer is desirably 0.3 to 1.5%.

### <Welding Step>

In the welding step, two or more Zn-based plated steel sheets are prepared and are spot welded at least at one location. Therefore, due to the welding step, a spot weld is formed between two steel sheets. As a result, it is possible to obtain a steel welded member comprised of a plurality of Zn-based plated steel materials, each comprised of a steel sheet and a Zn-based plating layer on its surface, joined by at least one spot weld. It should be noted that, if at least one of the Zn-based plated steel sheets is obtained by the above illustrative production process, it is possible to obtain the effect of improvement of the LME resistance at the plated steel sheet. Only naturally, if the other material to be welded with is a plated steel sheet of the same quality as the at least one Zn-based plated steel material, an effect of improvement of the LME resistance can be obtained even at the other material. The conditions at the time of spot welding may be conditions known to persons skilled in the art. For example, dome radius type welding electrodes with 6 to 8 mm tip diameter can be used with a squeezing force of 1.5 to 6.0 kN, weld time of 0.1 to 1.0 s (5 to 50 cycles, power frequency 50 Hz), and weld current of 4 to 15 kA.

In the above way, when producing a steel welded member, by preparing a steel material having fine ferrite phases and fine internal oxides inside the same by going through a predetermined steel material preparation step (in particular a brushing step and annealing step) and using a Zn-based plated steel material comprised of that steel material and a Zn-based plating, it is possible to prepare a steel welded member with a difference of the Zn penetration depth of Zn from the Zn-based plating layer penetrating the steel material minus the depth of the internal oxidation layer formed at the steel material of 0.1 to 10.0 μm in range in the region near the end of the pressure weld of the spot weld.

### EXAMPLES

Below, examples will be used to explain the present invention in more detail, but the present invention is not limited to these examples in any way. In particular, unless indicated otherwise, the samples were prepared by the following procedure. Specific conditions employed in some of the comparative examples etc. will be explained separately.

Regarding the examples and comparative examples of the plated steel sheet

### (Fabrication of Steel Material Samples)

Each molten steel adjusted in chemical composition was cast to form a steel slab. The steel slab was hot rolled, pickled, then cold rolled to obtain cold rolled steel sheet. Next, this was air-cooled down to room temperature. The cold rolled steel sheet was pickled to remove the internal oxidation layer formed by the rolling down to the depth of the internal oxidation layer (μm) before annealing shown in Table 1. Next, a sample was taken from each cold rolled steel sheet by a method compliant with JIS G0417: 1999. The chemical composition of each steel sheet was analyzed by the ICP-MS method etc. The measured chemical composition of each steel sheet is shown in Tables 1 and 2. The thicknesses of the steel sheets used were in all cases 1.6 mm.

Next, some of the cold rolled steel sheets were coated with an NaOH 2.0% aqueous solution and pretreated by brush grinding using a heavy descaling grinding brush (D-100 made by Hotani) by a brush reduction of 2.0 mm and speed 600 rpm. After that, they were annealed by the hydrogen concentration, dew points, holding temperatures, and holding times shown in Tables 1 and 2 to prepare steel sheet samples. The presence of any pretreatment and the conditions of the annealing (humidifying zone, hydrogen concentration (%), dew point (° C.), holding temperature (° C.), and holding time(s)) are shown in Tables 1 and 2. The “rising temperature” in the column of the humidifying zone means humidification in the period from 300° C. or more to the holding temperature by the atmosphere of the above-mentioned hydrogen concentration and dew point, while “equal temperature” in the column of humidification means humidification during the holding time by the atmosphere of the above-mentioned hydrogen concentration and dew point. The rate of temperature rise at the time of annealing was made 1 to 10° C./s. In the annealing, the annealing was performed in the state applying 0.1 to 20 MPa or more tension to the cold rolled steel sheet in the rolling direction. It should be noted that, in each steel sheet sample, a JIS No. 5 tensile test piece having a direction perpendicular to the rolling direction as the long direction was obtained and the tensile test performed compliant with JIS Z 2241(2011). As a result, for each of Nos. 22 and 26, the tensile strength was less than 780 MPa. For the rest, it was 780 MPa or more.

### (Preparation of Zn-Based Plated Steel Material Samples)

Each obtained steel material sample was cut to 100 mm×200 mm size, then plated for forming the plating type shown in Tables 1 and 2 to thereby prepare a plated steel material sample. In Tables 1 and 2, the plating type “a” means “hot dip galvannealed sheet (GA)”, the plating type “b” means “hot dip galvanized-0.2% Al plated steel sheet (GI)”, the plating type “c” means “hot dip galvanized-(0.3 to 1.5)% Al plated steel sheet (Al contents described in Tables 1 and 2)”, and the plating type “d” means “electrogalvanization (Al composition less than 0.01%)”. In the hot dip galvanization step, the cut sample was dipped in a 440° C. hot dip galvanization bath for 3 seconds. After dipping, it was pulled out at 100 mm/s and controlled to an amount of plating deposition of 50 g/m² by N₂ wiping gas. For the plating type “a”, alloying was subsequently performed at 500° C. Regarding the later explained LME resistance, in the case of the plating type “c” with an Al content of 0.3 to 1.5 mass % and the case of the plating type “d” with electrogalvanization, the LME resistance was improved. The results are shown in Tables 1 and 2.

Each obtained plated steel material sample was evaluated for different evaluation items by the following evaluation methods. It should be noted that, for each plated steel material sample, a JIS No. 5 tensile test piece having a direction perpendicular to the rolling direction as the long direction was taken and was subjected to a tensile test compliant with JIS Z 2241(2011). As a result, for each of Nos. 22 and 26, the tensile strength was less than 780 MPa, while for the others, it was 780 MPa or more. The results are shown in Tables 1 and 2.

### (Fabrication of Steel Welded Member Samples)

Each Zn-based plated steel material sample was cut into a size of 50 mm×100 mm. Two pieces were prepared. The two Zn-based plated steel sheet samples were spot welded to obtain a steel welded member sample. The conditions of the spot welding were use of dome radius type welding electrodes with 8 mm tip diameter, with a weld angle of 5°, a squeezing force of 4.0 kN, a weld time of 0.5 s, and a weld current of 8 kA to obtain an evaluation sample of the steel welded member. It should be noted that, in Sample No. 43, an evaluation sample of the steel welded member was obtained under welding conditions similar to the other samples except for making the weld current 9 kA.

### (Analysis of Microstructure at Region of 10 to 300 μm From End of Pressure Weld)

Each evaluation sample was analyzed for microstructure at a region of 10 to 300 μm from the end of the pressure weld (region near end) using SEM examination and EDS analysis of the cross-section of the weld. Specifically, first, the sample was polished in cross-section in a direction perpendicular to the direction of the weld angle by spot welding to thereby prepare a cross-sectional sample of the weld, then a BSE image including the end of the pressure weld was obtained by an SEM and the end of the pressure weld, then the region of 10 to 300 μm from the end of the pressure weld of the spot weld (region near end) were identified from the BSE image. The BSE image was digitalized so as to differentiate the “granular type oxides” and the “crystal phases of the steel (aggregate structures of crystal grains)” at the steel material (base iron) part of the identified region near the end to thereby identify the contours of the granular type oxides and measure the long axes, number, positions, etc. of the oxides observed. Further, based on the digitalized image, the “depth of the internal oxidation layer” including the granular type oxides was calculated. It should be noted that cracks and gaps etc. in the BSE image were differentiated from oxides using the elemental analysis SEM-EDS attached to the SEM. Next, for the Zn penetration depth, at the region near the end, the SEM power was made 2000×, any five fields (each field region being 30 ƒm×30 μm) were selected, and the positions where the interfaces of the plating layer/steel material (base iron) became near the centers of the fields were examined. From the elemental analysis images of Zn measured by the SEM-EDS, the maximum Zn penetration depth in the fields was defined as the “Zn penetration depth”. For the depth of the internal oxidation layer, at the region near the end, a single location was selected. The regions for observation of a total of 10 locations (field regions of examination regions being 10 to 300 μm) were selected at suitable measurement intervals from there. The examination regions of the 10 locations may overlap, but the total length Lo of the widths of the steel sheet actually examined is made 100 μm, the measured depth is made the region from the surface of the steel sheet down to 30 μm, and the distance from the surface of the steel sheet to the furthest position where any of the granular type oxides is present is defined as the “depth of internal oxidation layer” (Rn). The “depth of internal oxidation layer”, “Zn penetration depth”, and the difference of the same (“Zn penetration depth-depth of internal oxidation layer” are shown in Tables 1 and 2.

### (Evaluation of Spot Weld LME Resistance)

Each evaluation sample of each steel welded member sample was examined under an optical microscope at the cross-section of the part including the spot weld (nugget and pressure weld) and steel material after the completion of the welding (for example, the part such as in FIG. 1). The length of any LME fracture occurring at the weld cross-section of the examined image was measured and evaluation conducted by the following criteria. The results are shown in Tables 1 and 2.
Evaluation AAA: no LME fractures
Evaluation AA: LME crack length more than 0 μm to 100 μm
Evaluation A: LME crack length more than 100 μm to 500 μm
Evaluation B: LME crack length more than 500 μm

TABLE 1

| | | | | | | | | | | | | Thickness | | Heat treatment conditions | |
|---|---|---|---|---|---|---|---|---|---|---|---|---|---|---|---|
| | | | | | | | | | | | | of internal | | Humidifying | |
| | | | | | | | | | | | | oxidation | | zone (RT: | |
| | | | | | | | | | | | | layer at | | rising temp., | H2 |
| | | Chemical composition (mass %) | | | | | | | | | | hot rolling | Brush | ET: equal | conc. |
| No. | Class | Fe | C | Si | Mn | Al | P | S | N | B | Others | (μm) | grinding | temp.) | (%) |
| 1 | Ex. | Bal. | 0.05 | 1.1 | 2.0 | 0.4 | 0.0009 | 0.0001 | 0.0009 | 0.00002 | | 0.5 | Yes | RT + ET | 10 |
| 2 | Ex. | Bal. | 0.10 | 2.0 | 2.0 | 0.4 | 0.0054 | 0.0014 | 0.0004 | 0.00002 | Hf: 0.001 | 0 | Yes | RT + ET | 10 |
| 3 | Ex. | Bal. | 0.10 | 0.8 | 2.2 | 0.5 | 0.0001 | 0.0010 | 0.0023 | 0.00001 | | 0 | Yes | RT + ET | 10 |
| 4 | Ex. | Bal. | 0.10 | 1.6 | 2.2 | 0.5 | 0.0015 | 0.0009 | 0.0004 | 0.00002 | Mg: 0.001 | 0 | Yes | RT + ET | 10 |
| 5 | Ex. | Bal. | 0.20 | 0.5 | 2.3 | 0.5 | 0.0030 | 0.0009 | 0.0010 | 0.00001 | Zr: 0.0001 | 0 | Yes | RT | 10 |
| 6 | Ex. | Bal. | 0.20 | 1.0 | 2.0 | 0.5 | 0.0020 | 0.0008 | 0.0003 | 0.00003 | | 0 | Yes | RT + ET | 10 |
| 7 | Ex. | Bal. | 0.20 | 1.1 | 2.0 | 0.5 | 0.0012 | 0.0009 | 0.0004 | 0.00002 | Cr: 0.01 | 0 | Yes | RT + ET | 10 |
| 8 | Ex. | Bal. | 0.20 | 2.5 | 2.5 | 0.5 | 0.0015 | 0.0013 | 0.0003 | 0.00001 | | 0.1 | Yes | RT + ET | 10 |
| 9 | Ex. | Bal. | 0.20 | 3.0 | 2.0 | 0.5 | 0.0021 | 0.0015 | 0.0004 | 0.00002 | Ti: 0.02 | 0 | Yes | RT | 10 |
| 10 | Ex. | Bal. | 0.20 | 1.4 | 2.2 | 0.8 | 0.0060 | 0.0008 | 0.0004 | 0.00002 | | 0 | Yes | RT + ET | 10 |
| 11 | Ex. | Bal. | 0.20 | 0.8 | 2.2 | 0.7 | 0.0054 | 0.0024 | 0.0016 | 0.00002 | Ni: 0.01 | 0 | Yes | RT + ET | 10 |
| 12 | Ex. | Bal. | 0.25 | 0.8 | 2.2 | 0.7 | 0.0073 | 0.0021 | 0.0011 | 0.00002 | Cu: 0.002 | 0 | Yes | RT + ET | 10 |
| 13 | Ex. | Bal. | 0.25 | 1.1 | 2.2 | 1.0 | 0.0053 | 0.0015 | 0.0008 | 0.00001 | Nb: 0.009 | 0 | Yes | RT + ET | 10 |
| 14 | Ex. | Bal. | 0.30 | 1.0 | 5.0 | 1.2 | 0.0090 | 0.0014 | 0.0011 | 0.00002 | V: 0.0001 | 0 | Yes | RT + ET | 10 |
| 15 | Ex. | Bal. | 0.30 | 0.9 | 0.3 | 1.2 | 0.0067 | 0.0014 | 0.0016 | 0.00001 | | 0 | Yes | RT + ET | 10 |
| 16 | Ex. | Bal. | 0.35 | 0.5 | 2.4 | 1.0 | 0.0090 | 0.0020 | 0.0007 | 0.00002 | Mo: 0.007 | 0 | Yes | RT + ET | 10 |
| 17 | Ex. | Bal. | 0.35 | 1.0 | 2.2 | 0.5 | 0.0075 | 0.0018 | 0.0020 | 0.00001 | REM: 0.0001 | 0 | Yes | RT + ET | 10 |
| 18 | Ex. | Bal. | 0.40 | 1.1 | 2.2 | 0.5 | 0.0053 | 0.0012 | 0.0007 | 0.00002 | W: 0.0001 | 0 | Yes | RT + ET | 10 |
| 19 | Ex. | Bal. | 0.40 | 1.1 | 2.2 | 0.5 | 0.0049 | 0.0016 | 0.0006 | 0.00002 | | 0 | Yes | RT + ET | 10 |
| 20 | Ex. | Bal. | 0.40 | 1.0 | 2.2 | 0.5 | 0.0073 | 0.0018 | 0.0020 | 0.00002 | Ca: 0.0002 | 0 | Yes | RT + ET | 10 |
| 21 | Ex. | Bal. | 0.40 | 1.0 | 2.2 | 0.5 | 0.0049 | 0.0012 | 0.0004 | 0.00001 | | 0 | Yes | RT + ET | 10 |
| 36 | Ex. | Bal. | 0.20 | 1.0 | 2.0 | 0.8 | 0.0012 | 0.0009 | 0.0004 | 0.00001 | | 0 | Yes | RT + ET | 8 |
| 37 | Ex. | Bal. | 0.20 | 1.0 | 2.0 | 0.8 | 0.0010 | 0.0010 | 0.0001 | 0.00002 | | 0 | Yes | RT + ET | 14 |
| 38 | Ex. | Bal. | 0.20 | 0.9 | 1.8 | 1.5 | 0.0010 | 0.0011 | 0.0002 | 0.00001 | | 0 | Yes | RT + ET | 16 |
| 39 | Ex. | Bal. | 0.20 | 1.0 | 2.2 | 0.8 | 0.0012 | 0.0009 | 0.0001 | 0.00002 | | 0 | Yes | RT + ET | 20 |
| 40 | Ex. | Bal. | 0.20 | 1.0 | 2.2 | 0.8 | 0.0012 | 0.0009 | 0.0001 | 0.00002 | | 0 | Yes | RT + ET | 10 |
| 41 | Ex. | Bal. | 0.20 | 1.0 | 2.2 | 0.8 | 0.0012 | 0.0009 | 0.0001 | 0.00002 | | 0 | Yes | RT + ET | 10 |
| 42 | Ex. | Bal. | 0.20 | 1.0 | 2.2 | 0.8 | 0.0012 | 0.0009 | 0.0001 | 0.00002 | | 0 | Yes | RT + ET | 10 |
| 43 | Ex. | Bal. | 0.20 | 1.0 | 2.2 | 0.8 | 0.0012 | 0.0009 | 0.0001 | 0.00002 | | 0 | Yes | RT + ET | 10 |

| | | | | | | Max. Zn | | | |
|---|---|---|---|---|---|---|---|---|---|
| | | | | | | penetration | | | |
| | | | | Depth of | | depth - | | | |
| | Heat treatment conditions | | | internal | Max. Zn | internal | | | |
| | Dew | Holding | Holding | oxidation | penetration | oxidation | Tensile | | |
| | point | temp | time | layer | depth | layer depth | strength | Plating | LME |
| No. | (° C.) | (° C.) | (s) | (μm) | (μm) | (μm) | [MPa] | type | resistance |
| 1 | 10.3 | 900 | 5 | 3.2 | 3.7 | 0.5 | 780 | a | A |
| 2 | 10.2 | 900 | 50 | 4.1 | 4.9 | 0.8 | 790 | d | AA |
| 3 | 10.2 | 900 | 300 | 5.0 | 6.4 | 1.4 | 820 | b | A |
| 4 | 10.3 | 840 | 10 | 3.3 | 4.5 | 1.2 | 820 | d | AA |
| 5 | 10.2 | 840 | 0 | 4.9 | 5.0 | 0.1 | 900 | d | AA |
| 6 | 10.4 | 840 | 50 | 3.5 | 7.0 | 3.5 | 980 | d | AAA |
| 7 | 19.8 | 840 | 130 | 4.9 | 6.9 | 2.0 | 980 | c: 0.8% Al | AAA |
| 8 | 19.9 | 840 | 300 | 15.0 | 15.6 | 0.6 | 1040 | a | AA |
| 9 | 10.2 | 700 | 0 | 1.5 | 2.1 | 0.6 | 890 | b | A |
| 10 | 10.2 | 700 | 100 | 2.0 | 2.9 | 0.9 | 880 | c: 1.5% Al | AAA |
| 11 | 10.1 | 700 | 300 | 5.6 | 6.3 | 0.7 | 780 | a | A |
| 12 | 10.4 | 840 | 50 | 4.0 | 5.6 | 1.6 | 900 | d | AAA |
| 13 | 10.2 | 840 | 120 | 6.7 | 8.8 | 2.1 | 900 | d | AAA |
| 14 | 10.3 | 800 | 10 | 3.0 | 4.0 | 1.0 | 1470 | b | A |
| 15 | 10.2 | 800 | 100 | 4.1 | 8.4 | 4.3 | 1330 | d | AAA |
| 16 | 10.2 | 800 | 300 | 6.3 | 7.1 | 0.8 | 1180 | b | A |
| 17 | 10.1 | 830 | 50 | 4.5 | 6.2 | 1.7 | 1180 | d | AAA |
| 18 | 10.4 | 780 | 50 | 4.1 | 6.3 | 2.2 | 1470 | c: 0.3% Al | AAA |
| 19 | 10.2 | 780 | 100 | 2.7 | 4.5 | 1.8 | 1450 | d | AAA |
| 20 | 10.2 | 780 | 240 | 5.0 | 5.8 | 0.8 | 1500 | d | AA |
| 21 | 20.0 | 840 | 50 | 5.2 | 7.7 | 2.5 | 1520 | d | AAA |
| 36 | 20.4 | 820 | 130 | 3.5 | 6.2 | 2.7 | 980 | d | AAA |
| 37 | 19.8 | 820 | 130 | 2.9 | 6.5 | 3.6 | 980 | d | AAA |
| 38 | 19.9 | 820 | 130 | 2.4 | 6.1 | 3.7 | 980 | d | AAA |
| 39 | 19.7 | 830 | 130 | 2.4 | 6.0 | 3.6 | 980 | d | AAA |
| 40 | 11.1 | 830 | 130 | 2.3 | 5.6 | 3.3 | 980 | d | AAA |
| 41 | 15.2 | 830 | 130 | 2.5 | 5.1 | 2.6 | 980 | d | AAA |
| 42 | 18.9 | 830 | 130 | 2.4 | 5.7 | 3.3 | 980 | d | AAA |
| 43 | 11.4 | 830 | 130 | 2.5 | 6.0 | 3.5 | 980 | d | AAA |

TABLE 2

| | | | | | | | | | | | | Thickness | | Heat treatment conditions | |
|---|---|---|---|---|---|---|---|---|---|---|---|---|---|---|---|
| | | | | | | | | | | | | of internal | | Humidifying | |
| | | | | | | | | | | | | oxidation | | zone (RT: | |
| | | | | | | | | | | | | layer at | | rising temp., | H2 |
| | | Chemical composition (mass %) | | | | | | | | | | hot rolling | Brush | ET: equal | conc. |
| No. | Class | Fe | C | Si | Mn | Al | P | S | N | B | Others | (μm) | grinding | temp.) | (%) |
| 22 | C. ex. | Bal. | 0.03 | 1.5 | 2.0 | 0.6 | 0.0005 | 0.0009 | 0.0012 | 0.00002 | | 0 | Yes | RT + ET | 10 |
| 23 | C. ex. | Bal. | 0.20 | 1.5 | 2.0 | 0.6 | 0.0050 | 0.0020 | 0.0010 | 0.00002 | | 0 | Yes | RT + ET | 20 |
| 24 | C. ex. | Bal. | 0.20 | 1.5 | 2.0 | 0.6 | 0.0010 | 0.0012 | 0.0010 | 0.00001 | | 0 | Yes | RT + ET | 10 |
| 25 | C. ex. | Bal. | 0.20 | 1.5 | 2.0 | 0.6 | 0.0050 | 0.0020 | 0.0020 | 0.00002 | | 0 | Yes | RT + ET | 10 |
| 26 | C. ex. | Bal. | 0.20 | 1.5 | 2.0 | 0.6 | 0.0011 | 0.0029 | 0.0010 | 0.00001 | | 0 | Yes | RT + ET | 10 |
| 27 | C. ex. | Bal. | 0.20 | 1.8 | 2.0 | 0.6 | 0.0029 | 0.0025 | 0.0010 | 0.00002 | | 0 | No | RT | 10 |
| 28 | C. ex. | Bal. | 0.20 | 1.5 | 2.0 | 0.6 | 0.0026 | 0.0055 | 0.0024 | 0.00001 | | 0 | Yes | RT + ET | 10 |
| 29 | C. ex. | Bal. | 0.20 | 4.3 | 2.0 | 1.0 | 0.0011 | 0.0035 | 0.0020 | 0.00002 | | 0 | Yes | RT + ET | 10 |
| 30 | C. ex. | Bal. | 0.20 | 0 | 2.0 | 1.2 | 0.0064 | 0.0012 | 0.0022 | 0.00001 | | 0 | Yes | RT + ET | 10 |
| 31 | C. ex. | Bal. | 0.20 | 1.7 | 6.2 | 1.2 | 0.0026 | 0.0025 | 0.0032 | 0.00002 | | 0 | Yes | RT + ET | 10 |
| 32 | C. ex. | Bal. | 0.20 | 1.5 | 0 | 0.8 | 0.0014 | 0.0038 | 0.0044 | 0.00002 | | 0 | Yes | RT + ET | 10 |
| 33 | C. ex. | Bal. | 0.20 | 1.7 | 2.0 | 2.0 | 0.0088 | 0.0041 | 0.0044 | 0.00002 | | 0 | Yes | RT + ET | 10 |
| 34 | C. ex. | Bal. | 0.20 | 1.7 | 2.0 | 0.3 | 0.0014 | 0.0035 | 0.0032 | 0.00000 | | 0 | Yes | RT + ET | 10 |
| 35 | C. ex. | Bal. | 0.20 | 1.7 | 2.0 | 0.7 | 0.0067 | 0.0038 | 0.0050 | 0.00002 | | 0 | Yes | RT + ET | 4 |
| 44 | C. ex. | Bal. | 0.20 | 1.7 | 2.0 | 0.8 | 0.0067 | 0.0030 | 0.0050 | 0.00002 | | 0.8 | Yes | RT + ET | 10 |
| 45 | C. ex. | Bal. | 0.20 | 1.5 | 2.0 | 0.7 | 0.0022 | 0.0055 | 0.0020 | 0.00001 | | 0 | Yes | RT + ET | 10 |
| 46 | C. ex. | Bal. | 0.20 | 1.5 | 2.0 | 0.7 | 0.0011 | 0.0003 | 0.0012 | 0.00002 | | 0 | Yes | RT + ET | 20 |
| 47 | C. ex. | Bal. | 0.20 | 1.5 | 2.0 | 0.7 | 0.0011 | 0.0003 | 0.0012 | 0.00002 | | 0 | Yes | RT + ET | 20 |
| 48 | C. ex. | Bal. | 0.20 | 1.7 | 2.0 | 0.8 | 0.0067 | 0.0030 | 0.0050 | 0.00002 | | 0 | Yes | RT + ET | 7 |
| 49 | C. ex. | Bal. | 0.20 | 1.7 | 2.0 | 0.8 | 0.0067 | 0.0030 | 0.0050 | 0.00002 | | 0 | Yes | RT + ET | 22 |
| 50 | C. ex. | Bal. | 0.20 | 1.7 | 2.0 | 0.8 | 0.0067 | 0.0030 | 0.0050 | 0.00002 | | 0 | Yes | ET | 10 |

| | | | | | | Max. Zn | | | |
|---|---|---|---|---|---|---|---|---|---|
| | | | | | | penetration | | | |
| | | | | Depth of | | depth - | | | |
| | Heat treatment conditions | | | internal | Max. Zn | internal | | | |
| | Dew | Holding | Holding | oxidation | penetration | oxidation | Tensile | | |
| | point | temp. | time | layer | depth | layer depth | strength | Plating | LME |
| No. | (° C.) | (° C.) | (s) | (μm) | (μm) | (μm) | [MPa] | type | resistance |
| 22 | 10.2 | 750 | 50 | 3.8 | 2.4 | −1.4 | 400 | a | B |
| 23 | 0.2 | 750 | 50 | 4.0 | 4.0 | 0.0 | 830 | a | B |
| 24 | 39.9 | 750 | 50 | Plating not possible | | | | | |
| 25 | 10.1 | 950 | 50 | 11.1 | 8.8 | −2.3 | 790 | a | B |
| 26 | 10.2 | 650 | 50 | 3.0 | 2.9 | −0.1 | 580 | a | B |
| 27 | 10.2 | 750 | 0 | 3.0 | 2.8 | −0.2 | 840 | a | B |
| 28 | 10.1 | 880 | 350 | 16.6 | 10.1 | −6.5 | 820 | a | B |
| 29 | 19.9 | 750 | 50 | Plating not possible | | | | | |
| 30 | 10.2 | 750 | 50 | 3.5 | 3.5 | 0.0 | 880 | a | B |
| 31 | 10.1 | 750 | 50 | Plating not possible | | | | | |
| 32 | 10.2 | 750 | 50 | 3.3 | 2.1 | −1.2 | 1180 | a | B |
| 33 | 10.1 | 750 | 50 | Plating not possible | | | | | |
| 34 | 10.4 | 750 | 50 | 3.2 | 2.6 | −0.6 | 820 | a | B |
| 35 | 0.1 | 750 | 50 | Plating not possible | | | | | |
| 44 | 11.1 | 750 | 50 | 2.8 | 2.0 | −0.8 | 870 | a | B |
| 45 | 11.0 | 880 | 310 | 10.0 | 6.7 | −3.3 | 820 | a | B |
| 46 | 9.6 | 800 | 50 | 1.5 | 1.2 | −0.3 | 830 | a | B |
| 47 | 22.2 | 750 | 50 | Plating not possible | | | | | |
| 48 | 10.8 | 750 | 50 | 4.3 | 3.1 | −1.2 | 830 | a | B |
| 49 | 10.9 | 750 | 50 | 2.0 | 1.5 | −0.5 | 830 | a | B |
| 50 | 11.0 | 800 | 50 | 4.2 | 3.1 | −1.1 | 830 | a | B |

In each of Sample Nos. 1 to 21 and 36 to 43 of Table 1, at the region of 10 to 300 μm from the end of the pressure weld of the spot weld, the difference of the Zn penetration depth of Zn from the Zn-based plating layer penetrating the steel material minus the depth of the internal oxidation layer formed at the steel material was 0.1 μm or more in range, so high LME resistance was possessed and high strength was also possessed. Sample Nos. 22 to 35 and 44 to 50 of Table 2 are comparative examples outside the scope of the present invention. In Sample No. 22, the amount of C was insufficient and sufficient strength could not be obtained. In Sample No. 23, the dew point at the time of annealing was low, fine internal oxides were not sufficiently formed, further, fine ferrite phases were not sufficiently formed, the difference of the Zn penetration depth minus the depth of the internal oxidation layer did not become sufficiently large, and high LME resistance could not be obtained. In Sample No. 24, the dew point at the time of annealing was high, an external oxidation layer was formed on the surface of the steel sheet, and a plating layer could not be obtained. In Sample No. 25, the holding temperature at the time of annealing was high, the internal oxides inside the ferrite phases coarsened, the desired fine internal oxides were not obtained, further, the ferrite phases also grew and the desired fine ferrite phases were not obtained, the difference of the Zn penetration depth minus the depth of the internal oxidation layer did not become sufficiently large, and a high LME resistance could not be obtained. In Sample No. 26, the holding temperature at the time of annealing was low, fine internal oxides were not sufficiently obtained, further, the pinning effect of the ferrite phase grain boundaries by the internal oxides was insufficient, the ferrite phases coarsened, the difference of the Zn penetration depth minus the depth of the internal oxidation layer did not become sufficiently large, and a high LME resistance could not be obtained. Further, a sufficient high strength was also not obtained. In Sample No. 27, brush grinding was not performed before annealing, so fine internal oxides were not sufficiently obtained, further, fine ferrite phases were not formed, the difference of the Zn penetration depth minus the depth of the internal oxidation layer did not become sufficiently large, and a high LME resistance did not become sufficiently large, and high LME resistance could not be obtained. In Sample No. 28, the holding time at the time of annealing was long, the internal oxides in the ferrite phases coarsened, and a sufficiently large amount of fine internal oxides was not formed. Further, the pinning effect of the ferrite phase grain boundaries by the fine internal oxides was insufficient, the desired ferrite phases were not formed, the difference of the Zn penetration depth minus the depth of the internal oxidation layer did not become sufficiently large, and a high LME resistance could not be obtained. In each of Sample Nos. 29 and 31, the amount of Si and amount of Mn were respectively excessive, an external oxidation layer was formed on the surface of the steel sheet, and a plating layer could not be obtained. In each of Sample Nos. 30 and 32, the amount of Si and amount of Mn were respectively insufficient, fine ferrite phases were not sufficiently formed, the difference of the Zn penetration depth minus the depth of the internal oxidation layer did not become sufficiently large, and a high LME resistance could not be obtained. In Sample No. 33, the amount of Al was excessive, an external oxidation layer was formed on the surface of the steel sheet, and a plating layer could not be obtained. In Sample No. 34, the amount of Al was insufficient, fine internal oxides inside the ferrite phases were not sufficiently formed, the difference of the Zn penetration depth minus the depth of the internal oxidation layer did not become sufficiently large, and a high LME resistance could not be obtained. In Sample No. 35, as the humidifying atmosphere at the time of annealing, dew point 0.1° C. 4 vol % H₂ was used, an external oxidation layer was formed on the surface of the steel sheet, and a plating layer could not be obtained. In Sample No. 44, the cold rolled steel sheet was not pickled, the internal oxidation layer formed due to the rolling was left, then brush grinding and heat treatment were performed under the conditions described in Table 1. The depth of the internal oxidation layer of the cold rolled steel sheet was 0.8 μm, so fine ferrite phases and their internal oxides were not sufficiently formed and a high LME resistance could not be obtained. In Sample No. 45, the holding time at the time of annealing was long, the internal oxides in the ferrite phases coarsened, and a sufficiently large amount of fine internal oxides was not formed. Further, the pinning effect of the ferrite phase grain boundaries by the fine internal oxides was insufficient, the desired ferrite phases were not formed, the difference of the Zn penetration depth minus the depth of the internal oxidation layer did not become sufficiently large, and a high LME resistance could not be obtained. In Sample No. 46, the dew point at the time of annealing was low, an internal oxidation layer was not sufficiently formed, the difference of the Zn penetration depth minus the depth of the internal oxidation layer did not become sufficiently large, and a high LME resistance could not be obtained. In No. 47, the dew point at the time of annealing was high, an external oxidation layer was formed on the surface of the steel sheet, and a plating layer could not be obtained. In Sample No. 48, as the humidifying atmosphere at the time of annealing, dew point 11° C. 7 vol % H₂ was used, an external oxidation layer was formed, a fine internal oxidation layer was not sufficiently formed, the difference of the Zn penetration depth minus the depth of the internal oxidation layer did not become sufficiently large, and the LME resistance was insufficient. In Sample No. 49, as the humidifying atmosphere at the time of annealing, dew point 11° C. 22 vol % H₂ was used, the internal oxidation layer was not sufficiently formed, the pinning effect of the ferrite phase grain boundaries by the internal oxides was insufficient, the ferrite phases coarsened, the difference of the Zn penetration depth minus the depth of the internal oxidation layer did not become sufficiently large, and the LME resistance was insufficient. In Sample No. 50, humidification was not performed at the time of a rising temperature. Humidification was only performed at the time of an equal temperature. Therefore, a sufficiently large amount of fine internal oxides was not formed, the difference of the Zn penetration depth minus the depth of the internal oxidation layer did not become sufficiently large, and a high LME resistance could not be obtained.

In each of the invention examples, it was confirmed that in the region of 10 to 300 μm from the end of the pressure weld of the spot weld, the difference of the Zn penetration depth of Zn from the Zn-based plating layer penetrating the steel material minus the depth of the internal oxidation layer formed at the steel material was within 0.1 to 10.0 μm in range. For this reason, a high LME resistance was obtained. Further, a high strength was also obtained. On the other hand, in each of the comparative examples, the difference of the Zn penetration depth minus the depth of the internal oxidation layer did not become sufficiently large. For this reason, at least one of the following, i.e., the LME resistance was inferior, a plating layer was not obtained, or, further, a high strength was not obtained, was confirmed.

### INDUSTRIAL APPLICABILITY

According to the present invention, it becomes possible to provide a steel welded member having a high LME resistance of a spot weld. The steel welded member can be suitably used for automobiles, building materials, and other applications, in particular for automobiles. High LME resistance is exhibited and longer life can be expected as a steel welded member for automobile use. Therefore, the present invention can be said to be an invention with an extremely high industrial value.

### REFERENCE SIGNS LIST

1 steel welded member
11 Zn-based plated steel material
21 spot weld
23 nugget
25 pressure weld
27 end of pressure weld
28 nonjoined part (separation part)
29 plating layer in region near end (region of 10 to 300 μm from end of pressure weld)
41 steel sheet
44 base steel (steel crystal phases)
45 granular type oxides

1. A steel welded member comprised of a plurality of Zn-based plated steel materials, each comprised of a steel material and a Zn-based plating layer on its surface, joined by at least one spot weld, in which steel welded member,
at least one of the Zn-based plated steel materials has a 780 MPa or more tensile strength,
that steel material has a chemical composition containing, by mass %,
C: 0.05 to 0.40%,
Si: 0.2 to 3.0%,
Mn: 0.1 to 5.0%,
sol. Al: 0.4 to 1.50%,
P: 0.0300% or less,
S: 0.0300% or less,
N: 0.0100% or less,
B: 0 to 0.010%,
Ti: 0 to 0.150%,
Nb: 0 to 0.150%,
V: 0 to 0.150%,
Cr: 0 to 2.00%,
Ni: 0 to 2.00%,
Cu: 0 to 2.00%,
Mo: 0 to 1.00%,
W: 0 to 1.00%,
Ca: 0 to 0.100%,
Mg: 0 to 0.100%,
Zr: 0 to 0.100%,
Hf: 0 to 0.100%, and
REM: 0 to 0.10% and having a balance of Fe and impurities, and,
in a region of 10 to 300 μm from an end of a pressure weld of the spot weld, a difference of a Zn penetration depth of Zn from a Zn-based plating layer penetrating a steel material minus a depth of an internal oxidation layer formed at the steel material is within 0.1 to 10.0 μm in range.

2. The steel welded member according to claim 1, wherein the difference of the Zn penetration depth minus the depth of the internal oxidation layer is within 1.5 to 10.0 μm in range.

3. The steel welded member according to claim 1, wherein in a region of more than 1000 μm from the end of the pressure weld of the spot weld, the Zn-based plating layer has a chemical composition containing, by mass %, Al: 0.3 to 1.5% and having a balance of Zn and impurities.

4. The steel welded member according to claim 1, wherein in a region of more than 1000 μm from the end of the pressure weld of the spot weld, the Zn-based plating layer has a chemical composition containing, by mass %, Al: 0 to less than 0.1% and having a balance of Zn and impurities.

5. The steel welded member according to claim 2, wherein in a region of more than 1000 μm from the end of the pressure weld of the spot weld, the Zn-based plating layer has a chemical composition containing, by mass %, Al: 0.3 to 1.5% and having a balance of Zn and impurities.

6. The steel welded member according to claim 2, wherein in a region of more than 1000 μm from the end of the pressure weld of the spot weld, the Zn-based plating layer has a chemical composition containing, by mass %, Al: 0 to less than 0.1% and having a balance of Zn and impurities.
